(19) United States
(12) Patent Application Publication
(10) Pub. No.: US 2025/0135512 A1
(43) Pub. Date: May 1, 2025

(54) ELECTROSTATIC COLLECTING DEVICE

(71) Applicant: CANON KABUSHIKI KAISHA, Tokyo (JP)

(72) Inventors: YUKI NISHIZAWA, Kanagawa (JP); TOMOAKI NAKAI, Shizuoka (JP); JUNICHI SEKIYAMA, Tokyo (JP)

(21) Appl. No.: 18/923,870

(22) Filed: Oct. 23, 2024

(30) Foreign Application Priority Data
Oct. 31, 2023 (JP) 2023-187239

(51) Int. Cl. B08B 6/00; B08B 1/32; B08B 7/04; B08B 13/00

(52) U.S. Cl. CPC B08B 6/00; B08B 1/32; B08B 7/04; B08B 13/00

(57) ABSTRACT

An electrostatic collecting device includes a collecting member, a recovering member, and an electroconductive member. The collecting member is formed of an insulator so as to form a collecting portion in contact with an object-to-be-cleaned and to form a recovering portion in contact with the recovering member, and electrostatically collects a substance-to-be-collected from the object-to-be-cleaned in the collecting portion while being circumferentially moved. The recovering member is formed of an insulator and electrostatically recovers the substance-to-be-collected from the collecting member in the recovering portion while being circumferentially moved. When a shortest distance from the electroconductive member, passing through the collecting portion, to the object-to-be-cleaned is L1 and a shortest distance from the electroconductive member, passing through the recovering portion, to the recovering member is L2, the following relationship is satisfied: L1>L2.

### FIELD OF THE INVENTION AND RELATED ART

The present invention relates to an electrostatic collecting device for cleaning a substance-to-be-collected from an object-to-be-cleaned.

Conventionally, in various manufacturing facilities, industrial products, or domestic cleaners and the like, a technique for cleaning fine particles by using an electrostatic depositing force is proposed. Herein, “fine particles” refer to, for example, toner and paper powder in an electrophotographic image forming apparatus, dust (dirt) in the manufacturing facilities or at home, and the like.

For example, in Japanese Laid-Open Patent Application (JP-A) No. Hei 1-6989, an electrostatic collecting device (cleaning device) for cleaning toner on an electrostatic latent image bearing member in an electrophotographic image forming apparatus by using an electrostatic depositing force is disclosed. In Japanese Patent No. 4886097, an electrostatic collecting device (cleaning device) for cleaning dust (dirt) on a surface of a glass substrate, a printed circuit board (PCB, PCBA, or the like), a film, a sheet, a plastic plate, or the like by using the electrostatic depositing force is disclosed. In JP-A No. 2015-84993, an electrostatic collecting device (cleaning device) for cleaning dust (dirt) on a floor surface by using the electrostatic depositing force is disclosed.

These electrostatic collecting devices first electrostatically collect a substance-to-be-collected on an object-to-be-cleaned by a rotatable collecting body and recover the substance-to-be-collected, electrostatically deposited on the rotatable collecting body, by electrostatically transferring the substance-to-be-collected onto a rotatable recovering body.

As the rotatable collecting body, a brush roller provided with raising (nap), constituting a collecting member, at a periphery of a core portion, or the like member is used. Further, as the recovering member, a recovering roller including a surface layer constituting a recovering member or the like member is used.

### SUMMARY OF THE INVENTION

According to an aspect of the present invention, there is provided an electrostatic collecting device comprising: a collecting member configured to collect a substance-to-be-collected from an object-to-be-cleaned and capable of being circumferentially moved; a recovering member configured to recover the substance-to-be-collected from the collecting member and capable of being circumferentially moved; and an electroconductive member formed of an electric conductor and provided so as to oppose the recovering member positioned in a recovering portion through the collecting member positioned in the recovering portion, wherein the collecting member is formed of an insulator so as to form a collecting portion in contact with the object-to-be-cleaned and to form the recovering portion in contact with the recovering member, and electrostatically collects the substance-to-be-collected from the object-to-be-cleaned in the collecting portion while being circumferentially moved, wherein the recovering member is formed of an insulator and electrostatically recovers the substance-to-be-collected from the collecting member in the recovering portion while being circumferentially moved, and wherein when a shortest distance from the electroconductive member, passing through the collecting portion, to the object-to-be-cleaned is L1 and a shortest distance from the electroconductive member, passing through the recovering portion, to the recovering member is L2, the following relationship is satisfied: L1>L2.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus in an embodiment 1.

FIG. 2 is a schematic sectional view of a cleaning device according to the embodiment 1.

FIG. 3 is a schematic enlarged view of a cleaning portion in the embodiment 1.

FIG. 4 is a schematic enlarged view of a recovering portion in the embodiment 1.

Part (a) of FIG. 5 is a graph showing a relationship between a recovering portion clearance L2 and transfer efficiency of paper powder in the recovering portion, and part (b) of FIG. 5 is a graph showing a relationship between the recovering portion clearance L2 and Coulomb force Fe.

FIG. 6 is a schematic enlarged view showing an electric field in the recovering portion.

Parts (a) and (b) of FIG. 7 are graphs each showing the relationship between the recovering portion clearance L2 and the Coulomb force Fe.

FIG. 8 is a schematic sectional view of a cleaning device according to a modified embodiment of the embodiment 1.

FIG. 9 is a schematic sectional view of a cleaning device according to an embodiment 2.

FIG. 10 is a schematic sectional view of a cleaning device according to an embodiment 3.

FIG. 11 is a schematic perspective view of an outer appearance of a cleaning device according to an embodiment 4.

FIG. 12 is a schematic sectional view of the cleaning device according to the embodiment 4.

FIG. 13 is a schematic sectional view showing a paddle roller and a recovering roller in a cleaning device according to an embodiment 5.

FIG. 14 is a schematic sectional view of a cleaning device according to an embodiment 6.

### DESCRIPTION OF THE PREFERRED EMBODIMENTS

In the following, an electrostatic collecting device according to the present invention will be specifically described.

### Embodiment 1

In this embodiment, the electrostatic collecting device according to the present invention is used as a cleaning device for collecting a substance-to-be-collected from an object-to-be-cleaned.

### (1) Image Forming Apparatus

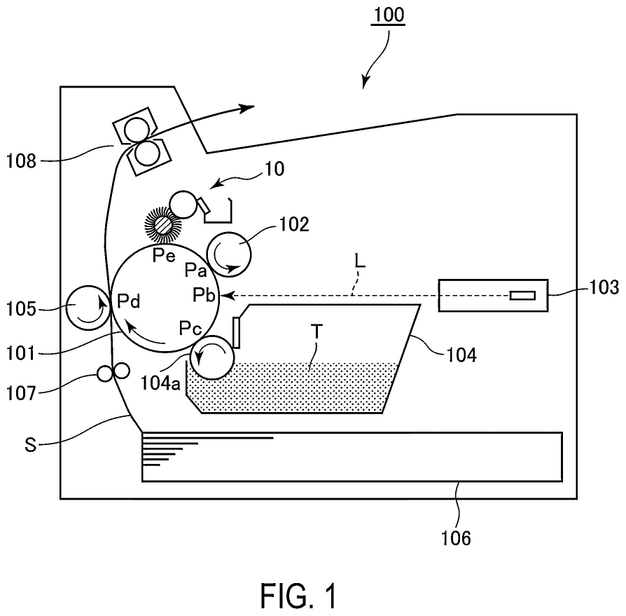

FIG. 1 is a schematic sectional view of an image forming apparatus 100 in which the electrostatic collecting device of this embodiment is used as the cleaning device (paper powder collecting device). In this embodiment, the image forming apparatus 100 is a monochromatic laser beam printer capable of forming a black (monochromatic) image by using an electrophotographic type.

The image forming apparatus 100 includes a photosensitive drum 101 which is a rotatable drum-type (cylindrical) photosensitive member (electrophotographic photosensitive member) as an image bearing member. When an image outputting operation is started, the photosensitive drum 101 is rotationally driven in an arrow direction (clockwise direction) in FIG. 1. In this embodiment, an outer diameter of the photosensitive drum 101 is 30 mm, and a peripheral speed (surface movement speed) of the photosensitive drum 101 is 140 mm/sec.

A surface of the rotating photosensitive drum 101 is electrically charged uniformly to a predetermined polarity (negative polarity in this embodiment) and a predetermined potential by a charging roller 102 which is a roller-type charging member as a charging means. The charging roller 102 contacts the surface of the photosensitive drum 101 in a charging position Pa with respect to a rotational direction of the photosensitive drum 101 while being rotated in an arrow direction in FIG. 1 with rotation of the photosensitive drum 101, and charges the surface of the photosensitive drum 101.

The charged surface of the photosensitive drum 101 is subjected to a scanning exposure by an exposure device (laser scanner device) 103 as an exposure device, so that an electrostatic latent image (electrostatic image) is formed on the photosensitive drum 101. The exposure device 103 irradiates the surface of the photosensitive drum 101, in an exposure position Pb with respect to the rotational direction of the photosensitive drum 101, with a laser beam L modulated depending on image data sent from an external device such as a personal computer to the image forming apparatus 100.

The electrostatic latent image formed on the photosensitive drum 101 is developed (visualized) by being supplied with toner T as a developer by a developing device 104 as a developing means, so that a toner image (toner picture, developer image) is formed on the photosensitive drum 101. The developing device 104 deposits the toner on the electrostatic latent image on the photosensitive drum 101 by a developing roller 104a contacting the photosensitive drum 101 in a developing position Pc with respect to the rotational direction of the photosensitive drum 101. During development, to the developing roller 104a, a predetermined developing voltage is applied by a developing high-voltage power source (not shown) as a developing high-voltage applying means. In this embodiment, on an exposed portion (image portion) on the photosensitive drum 101 lowered in absolute value of a potential by being exposed to light after being charged uniformly, toner T charged to the same polarity (negative polarity in this embodiment) as a charge polarity of the photosensitive drum 101 is deposited (reverse development type).

A transfer roller 105 which is a roller-type member as a transfer means is provided so as to contact the photosensitive drum 101 in a transfer position Pd with respect to the rotational direction of the photosensitive drum 101. The toner image formed on the photosensitive drum 101 is transferred in the transfer position Pd, onto a sheet-like recording material S such as paper nipped and fed by the photosensitive drum 101 and the transfer roller 105. The transfer roller 105 forms a transfer nip (transfer portion) in contact with the photosensitive drum 101 in the transfer position Pd. During transfer, to the transfer roller 105, a predetermined transfer voltage of an opposite polarity (positive polarity in this embodiment) to a normal charge polarity (principal charge polarity during the development) of the toner is applied. The recording material S is fed from a cassette 106 or the like as a recording material accommodating portion to the transfer portion (transfer position Pd) by a feeding roller 107 or the like as a feeding means while being timed to the toner image on the photosensitive drum 101.

The toner image on which the toner image is transferred is sent to a fixing device 108 as a fixing means. The fixing device 108 applies heat and pressure to the recording material S on which an unfixed toner image is carried, and fixes (melts, sticks) the toner image on the recording material S. The recording material S on which the toner image is fixed is discharged to an outside of the image forming apparatus 100.

Further, toner (transfer residual toner) remaining on the photosensitive drum 101 without being transferred onto the recording material S during the transfer is recovered by the developing device 104. The transfer residual toner deposited on the photosensitive drum 101 is transferred onto the developing roller 104a by a potential difference between the potential of the photosensitive drum 101 and the developing voltage, and is recovered from the developing roller 104a into the developing device 104, and then is used again for image formation.

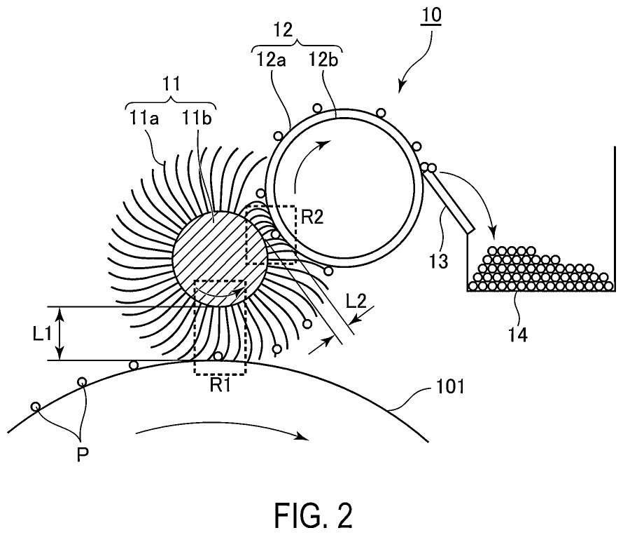

In the image forming apparatus 100 in this embodiment, the surface of the photosensitive drum 101 directly contacts the recording material S, and therefore, paper powder P (FIG. 2) is liable to be deposited on the surface of the photosensitive drum 101. When this paper powder P is recovered together with the toner T, remaining on the photosensitive drum 1, into the developing device 104, the paper powder P causes image defect in some cases. In the paper powder P, in addition to pulp fibers (cellulose derived from broad-leaved tree or needle-leaved tree), a filler for making paper transparent or white, an internal sizing agent for preventing bleeding of ink, an internal sizing fixing agent for attracting the internal sizing agent to the pulp fibers, and the like are contained. Of these substances, substances having a possibility of having the influence particularly on the electrophotographic process are the pulse fibers and the filler. When these substances are recovered into the developing device 104, a charge amount of the toner in the developing device 104 is lowered in some instances. Then, when the image forming operation is repeated in such a state, the charge amount of the toner in the developing device 104 becomes insufficient relative to a charge amount necessary for the image forming operation. When the toner charge amount becomes insufficient, a fog such that the toner is deposited in a thin layer on a region (non-image portion) on the photosensitive drum 101 where the image is not originally formed occurs in excess of an allowable range in some cases.

Therefore, the image forming apparatus 100 in this embodiment includes a cleaning device 10, constituted by the electrostatic collecting device according to the present invention, for collecting the paper powder P as a substance-to-be-collected from the surface of the photosensitive drum 101 as an object-to-be-cleaned. The cleaning device 10 collects the paper powder P from the surface of the photosensitive drum 101 at a collecting position Pe on a side downstream of the transfer position Pd and upstream of the charging position Pa with respect to the rotational direction of the photosensitive drum 101. The cleaning device 10 collects the paper powder P, charged to the positive polarity, from the surface of the photosensitive drum 101 as described later.

### (2) Cleaning Device

FIG. 2 is a schematic sectional view (showing a cross section substantially perpendicular to a rotational axis direction of a brush roller 11 described later) of the cleaning device 10 of this embodiment. The cleaning device 10 includes the brush roller 11 as a rotatable collecting body, a recovering roller 12 as a rotatable member, a cleaning blade 13 as a removing member (scraping-off member), and an accommodating container (accommodating portion).

The brush roller 11 includes raising (nap) (elastically deformable projection) 11a as an elastically deformable portion constituting a collecting member and a core portion (core metal) 11b as a supporting portion for supporting this raising 11a. The core portion 11b of the brush roller 11 is constituted by a cylindrical member and is disposed opposed to the photosensitive drum 101 so that a rotational axis direction thereof is substantially parallel to the rotational axis direction of the photosensitive drum 101. The core portion 11b of the brush roller 11 is rotatably supported by a casing (not shown) of the cleaning device 10 through a rotation shaft portion provided at each of opposite end portions thereof with respect to the rotational axis direction thereof. On an outer peripheral surface of the core portion 11b of the brush roller 11, raisings (naps) 11a of the brush roller 11 are provided. The raisings 11a of the brush roller 11 are provided substantially uniformly on the outer peripheral surface of the core portion 11b of the brush roller 11 in a range of a length equal to a length (for example, about 300 mm) of the photosensitive drum 101 in the rotational axis direction. In this embodiment, the brush roller 11 is constituted by directly planting the raisings 11a in the outer peripheral surface of the core portion 11b.

In this embodiment, the core portion 11b of the brush roller 11 is formed of aluminum which is an electroconductive metal material as an electric conductor (electroconductive material). Further, in this embodiment, the core portion 11b of the brush roller 11 is connected to ground potential (GND) (electrically grounded). Incidentally, in FIG. 2, the electric conductor part is applied with hatched lines (the same applies to other drawings). Further, the raising 11a of the brush roller 11 is formed of an insulating resin material as an insulator (electrical insulating material). As the material of the raising 11a of the brush roller 11, a material of which position in terms of triboelectric charge series is on a side negative relative to a substance-to-be-collected and positive relative to the material of the surface layer 12a of the recovering roller 12 is used. Particularly, in this embodiment, as the material of the raising 11a of the brush roller 11, a material of which position in terms of the triboelectric charge series is more separated from the paper powder P toward the negative side through the surface layer material of the photosensitive drum 101 may preferably be used. In this embodiment, the raising 11a of the brush roller 11 is formed on a PET fiber which is a fiber constituted by PET (polyethylene terephthalate) which is a kind of polyester resin. Incidentally, in this embodiment, the photosensitive drum 101 is an organic photoconductor (OPC), and the surface layer of the photosensitive drum 101 is formed by using, for example, a binder resin of PC (polycarbonate) or the like.

In this embodiment, the raising 11a of the brush roller 11 is 11 mm in natural length (pile length), the core portion 11b of the brush roller 11 is 6 mm in outer diameter, and the brush roller 11 is 28 mm in outer diameter (diameter). Incidentally, the natural length of the raisings 11a of the brush roller 11 is a length in the case where the raisings 11a are not deformed under application of pressure by the photosensitive drum 101 and the recovering roller 12. Further, the outer diameter of the brush roller 11 is a diameter of a circumscribed circle of the raisings 11a in a state of the natural length. Further, in this embodiment, a collecting portion clearance L1 which is a distance between the core portion 11b of the brush roller 11 and the photosensitive drum 101 is set to 10 mm. Accordingly, the brush roller 11 is rotated while the raisings 11a thereof contact the surface of the photosensitive drum 101. To the brush roller 11, a driving force is transmitted from a motor (not shown) as a driving source constituting a driving means, so that the brush roller 11 is rotated at a peripheral speed of 140 mm/sec (which is the same as the peripheral speed of the photosensitive drum 101) in an arrow direction (counterclockwise direction) in FIG. 2. That is, in a collecting portion R1 where the raisings 11a of the brush roller 11 and the photosensitive drum 101 are in contact with each other, the brush roller 11 is rotated so that a movement direction of the raisings 11a of the brush roller 11 and a surface movement direction of the photosensitive drum 101 become the same direction (forward direction). By rotation of the brush roller 11, the raisings 11a of the brush roller 11 is circumferentially moved. A thickness and a density of the raisings 11a of the brush roller 11 will be described later. Incidentally, the rotational direction and the peripheral speed of the brush roller 11 are not limited to those in this embodiment. In the collecting portion R1, the brush roller 11 may be rotated so that the movement direction of the raisings 11a of the brush roller 11 and the surface movement direction of the photosensitive drum 101 become opposite directions to each other. Further, the peripheral speed of the brush roller 11 may be made faster or slower than the peripheral speed in this embodiment.

The recovering roller 12 includes the surface layer 12a and a base portion 12b provided with the surface layer 12a on an outer periphery thereof. The base portion 12b of the recovering roller 12 is constituted by a cylindrical member and is disposed opposed to the brush roller 11 so that a rotational axis direction thereof and a rotational axis direction of the brush roller 11 (and the photosensitive drum 101) are substantially parallel to each other. A length of the recovering roller 12 in the rotational axis direction is equal to a length of a range (region) in which the raisings 11a of the brush roller 11 are provided along the rotational axis direction. In this embodiment, the base portion 12b of the recovering roller 12 is formed of ABS resin (acrylonitrile butadiene styrene resin) which is an electric insulator resin material as an insulator. Further, in this embodiment, the surface layer 12a of the recovering roller 12 is formed of an electric insulator resin material as an insulator. As the material of the surface layer 12a of the recovering roller 12, a material of which position in terms of triboelectric charge series is on a side negative relative to a substance-to-be-collected and the material of the raisings 11a of the brush roller 11 is used. Particularly, in this embodiment, as the material of the surface layer 12a of the recovering roller 12, a material of which position in terms of the triboelectric charge series is more separated from the paper powder P toward the negative side through PET which is the material of the raisings 11a of the brush roller 11 may preferably be used. In this embodiment, the surface layer 12a of the recovering roller 12 is formed on a PFA (tetrafluoroethylene-perfluoroalkylvinyl ether copolymer). In this embodiment, the recovering roller 12 is put in an electrically floated state.

In this embodiment, the surface layer 12a of the recovering roller 12 is 0.5 mm in thickness, the base portion 12b of the recovering roller 12 is 17 mm in diameter, and the recovering roller 12 is 18 mm in outer diameter. In this embodiment, a recovering portion clearance L2 which is a distance between the core portion 11b of the brush roller 11 and the recovering roller 12 is set to 7 mm. Accordingly, the recovering roller 12 is rotated while contacting the raisings 11a of the brush roller 11. To the recovering roller 12, a driving force is transmitted from a motor (not shown) as a driving source constituting a driving means, so that the recovering roller 12 is rotated at a peripheral speed of 140 mm/sec (which is the same as the peripheral speed of the brush roller 11) in an arrow direction (clockwise direction) in FIG. 2. That is, in a recovering portion R2 where the raisings 11a of the brush roller 11 and the recovering roller 12 are in contact with each other, the recovering roller 12 is rotated so that a movement direction of the raisings 11a of the brush roller 11 and a surface movement direction of the recovering roller 12 become the same direction (forward direction). By rotation of the recovering roller 12, the surface layer 12a of the recovering roller 12 is circumferentially moved. Incidentally, the rotational direction and the peripheral speed of the recovering roller 12 are not limited to those in this embodiment. In the recovering portion R2, the recovering roller 12 may be rotated so that the movement direction of the raisings 11a of the brush roller 11 and the surface movement direction of the recovering roller 12 become opposite directions to each other. Further, the peripheral speed of the recovering roller 12 may be made faster or slower than the peripheral speed in this embodiment.

The cleaning blade 13 is formed of polyurethane (urethane rubber) which is a rubber material as an elastic member (elastic material) having appropriate elasticity and hardness. The cleaning blade 13 is a rectangular plate-like member in plan view, which has a predetermined length and a predetermined thickness with respect to each of a longitudinal (long-side) direction and a widthwise (short-side) direction. The length of the cleaning blade 13 in the longitudinal direction is equal to the length of the recovering roller 12 in the longitudinal direction. The cleaning blade 13 is contacted to the surface of the recovering roller 12 at a free end portion thereof so that the free end portion which is one end portion with respect to the widthwise direction is positioned upstream of a fixed end portion which is the other end portion with respect to the surface movement direction of the recovering roller 12. That is, the cleaning blade 13 is contacted to the surface of the recovering roller 12 in a counter direction to the rotational direction of the recovering roller 12. The cleaning blade 13 may be fixed to a casing (not shown) of the cleaning device 10 through a cleaning blade supporting portion (not shown) formed of, for example, a plated steel plate or the like. Incidentally, the removing member is not limited to a blade-like member, but may be, for example, a pad-like member, a sheet-like member, a brush-like member, and the like.

Further, the accommodating container 14 is provided so as to accommodate the paper powder P scraped off from the surface of the rotating recovering roller 12 by the cleaning blade 13.

Here, the insulator refers to a substance of 10⁸ (Ω.m) or more, preferably 10¹⁰ (Ω.m) or more in volume resistivity. However, typically, the insulator is 10¹⁶ (Ω.m) or less in volume resistivity. Further, the electroconductive member (electric conductor) refers to a substance of 10⁻⁶ (Ω.m) or less, typically about 10⁻⁸ (Ω.m) in volume resistivity.

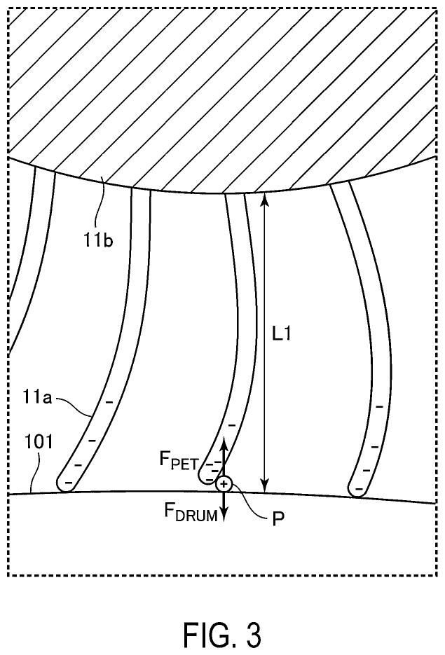

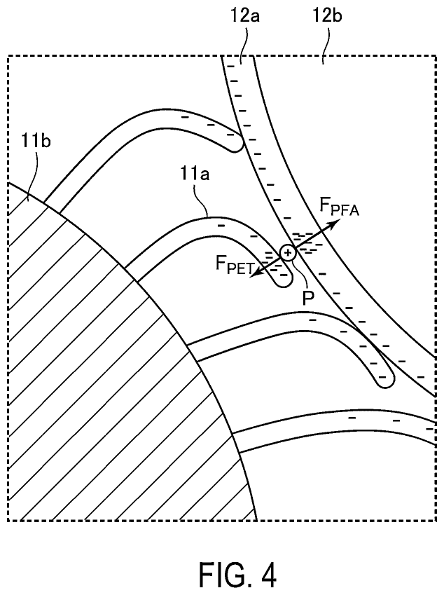

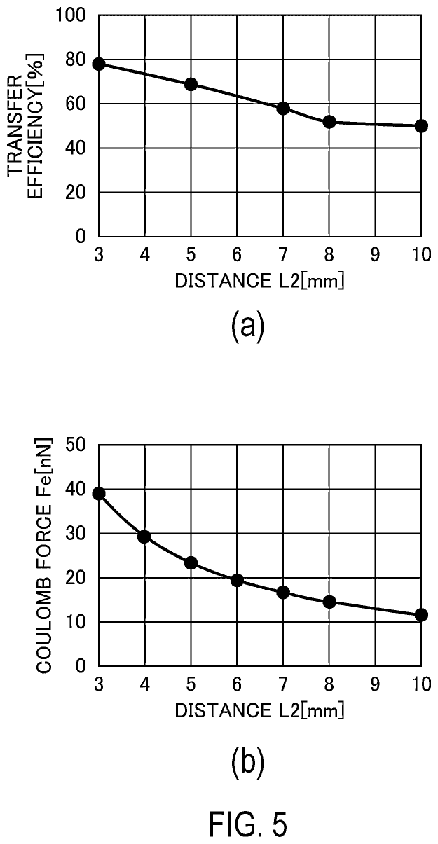

When two substances different in position of the triboelectric charge series are rubbed with each other, charges are exchanged to each other between the two substances, so that one substance is charged to the positive polarity, and the other substance is charged to the negative polarity. A series in which permutations of positive and negative substances are arranged is the triboelectric charge series, and in general, there is a tendency that the substances are charged more strongly with a remoter positional relationship. The brush roller 11 rubs the paper powder P, on the photosensitive drum 101 in the collecting portion R1 while being rotated, with the raisings 11a thereof, and collects the paper powder P on the raisings 11a by an electrostatic depositing force (electrostatic attraction force). FIG. 3 is a schematic enlarged view of the collecting portion R1. As shown in FIG. 3, in the collecting potion R1, an electrostatic depositing force F_{PET} acts between the paper powder P and the raising 11a of the brush roller 11, and an electrostatic depositing force F_{DRUM} acts between the paper powder P and the surface of the photosensitive drum 101. The raising 11a of the brush roller 11 is larger in charge amount per unit area than the surface of the photosensitive drum 101 on the basis of a positional relationship in the above-described triboelectric charge series. For that reason, in the collecting portion R1, by satisfying F_{PET}>F_{DRUM}, the paper powder P is collected by the raisings 11a of the brush roller 11. The paper powder P collected by the raisings 11a of the brush roller 11 reaches the recovering portion R2 by rotation of the brush roller 11. FIG. 4 is a schematic enlarged view of the recovering portion R2. As shown in FIG. 4, in the recovering portion R2, the electrostatic depositing portion F_{PET} acts between the paper powder P and the raising 11a of the brush roller 11, and an electrostatic depositing force F_{PFA} acts between the paper powder P and the surface layer 12a of the recovering roller 12. The surface layer 12a of the recovering roller 12 is larger in charge amount per unit area than the raising 11a of the brush roller 11 on the basis of a positional relationship in the above-described triboelectric charge series. For that reason, in the recovering portion R2, principally by satisfying F_{PFA}>F_{PET}, the paper powder P is transferred (recovered) onto the surface layer 12a of the recovering roller 12.

Thereafter, the paper powder P deposited on the surface layer 12a of the recovering roller 12 is scraped off by the cleaning blade 13, and is accommodated in the accommodating container 14. Trough the above-described process, the paper powder P deposited on the surface of the photosensitive drum 101 is removed and recovered from the surface of the photosensitive drum 101.

As described above, in this embodiment, the recovering portion clearance L2 is set to 7 mm, and the natural length of the raising 11a of the brush roller 11 is 11 mm. Accordingly, in the recovering portion R2, the raising 11a of the brush roller 11 is bent by 4 mm in contact with the recovering roller 12.

Part (a) of FIG. 5 is a graph showing a change in transfer efficiency of the paper powder P from the brush roller 11 onto the recovering roller 12. In part (a) of FIG. 5, an abscissa represents the recovering portion clearance L2, and an ordinate represents the transfer efficiency of the paper powder P from the brush roller 11 onto the recovering roller 12. Incidentally, the transfer efficiency of the paper powder P from the brush roller 11 onto the recovering roller 12 is more specifically is transfer efficiency of the paper powder P from the raising 11a of the brush roller 11 onto the surface layer 12a of the recovering roller 12 (herein, this transfer efficiency is simply referred to as “transfer efficiency”).

Here, the transfer efficiency in the recovering portion R2 can be acquired in the following manner. First, the brush roller 11 on which the paper powder P is not deposited is demounted from the image forming apparatus 100 (cleaning device 10), and a weight of the brush roller 11 is measured by an electrobalance. Further, the paper powder P is deposited on the brush roller 11, and a weight of the brush roller 11 on which the paper powder P is deposited is measured by the electrobalance. As the paper powder P, typical paper powder (containing pulp fibers, a filler such as talc) generated from plain paper used in the image forming apparatus 100 was used. Further, by acquiring a difference in weight of the brush roller 11 between before and after the above-described deposition of the paper powder P, a deposition amount M1 of the paper powder P on the brush roller 11 is specified. Then, the brush roller 11 on which the above-described paper powder P is deposited is mounted in the image forming apparatus 100 (cleaning device 10), and is rotated once together with the recovering roller 12. Thereafter, the brush roller 11 is demounted again from the image forming apparatus 100 (cleaning device 10), and the weight of the brush roller 11 is measured by the electrobalance. Then, by acquiring a difference in weight of the brush roller 11 between before and after the above-described rotation, a deposition amount M2 of the paper powder P on the brush roller 11 after the above-described rotation is specified. By this, the deposition amounts M1 and M2 of the paper powder P on the brush roller 11 before and after the one rotation of the brush roller 11 can be specified. Further, transfer efficiency in the recovering portion R2 by one rotation of the brush roller 11 can be acquired by the following formula: (1−M2/M1)×100.

From part (a) of FIG. 5, it is understood that there is a tendency that the transfer efficiency in the recovering portion R2 increase with a decreasing recovering portion clearance L2. Particularly, it is understood that there is a tendency that a change amount (increasing rate) of the transfer efficiency in the recovering portion R2 becomes large by making the recovering portion clearance L2 not more than 8 mm, preferably not more than 7 mm.

Thus, it is preferable that the recovering portion clearance L2 is made small as can as possible (preferably 8 mm or less, more preferably 7 mm or less). By this, the transfer efficiency in the recovering portion R2 can be improved. Details of a mechanism for improving the transfer efficiency in the recovering portion R2 will be described later. In this embodiment, from this viewpoint, the recovering portion clearance L2 is set to 7 mm.

On the other hand, in this embodiment, the collecting portion clearance L1 may preferably be made large as can as possible (preferably 10 mm or more) in a range in which the raising 11a of the brush roller 11 is contactable to the surface of the photosensitive drum 101 which is an object-to-be-cleaned. Details of a reason of this will be described later. In this embodiment, from this viewpoint, the collecting portion clearance L1 is set to 10 mm. In this embodiment, the natural length of the raising 11a of the brush roller 11 is 11 mm. Accordingly, in the collecting portion R1, the raisings 11a of the brush roller 11 are bent by 1 mm in contact with the photosensitive drum 101.

However, in a constitution of this embodiment, when the brush roller 11 is stored for a long term in a state in which the raisings 11a of the brush roller 11 are crushed by 40% or more, there is a possibility that resin constituting the raisings 11a causes permanent deformation. Further, when the raisings 11a of the brush roller 11 are crushed by 50% or more, there is a possibility that a rotation torque of the brush roller 11 excessively increases. When the rotation torque of the brush roller 11 excessively increases, upsizing of a driving means becomes a problem in some cases. For that reason, a crushing amount of the raisings 11a of the brush roller 11 by the recovering roller 12 may preferably be about 30%, more specifically 40% or less. Incidentally, as described above, in order to make the recovering portion clearance L2 smaller or the like, the crushing amount of the raisings 11a of the brush roller 11 by the recovering roller 12 is made typically 25% or more. Here, the crushing amount of the raisings 11a of the brush roller 11 by the recovering roller 12 is represented by (L1−L2)/L0×100 in the case where the natural length of the raising 11a is L0. In other words, a ratio of the recovering portion clearance L2 to the natural length L0 of the raising 11a of the brush roller 11, represented by L2/L0×100 may preferably be about 70%, more specifically 60% or more. In this embodiment, L0=11 mm and L2=7 mm are set, so that the crushing amount is about 37%, and the ratio of the recovering portion clearance L2 to the natural length L0 of the raising 11a of the brush roller 11 is about 63%.

Further, in the constitution of this embodiment, it is desirable that density and rigidity of the raisings 11a of the brush roller 11 are set so that the rotation torque of the brush roller 11 does not excessively increase even when the raisings 11a are crushed as described above. A thickness of each raising 11a of the brush roller 11 may preferably be 10 denier or more from the viewpoint of a collecting performance. Similarly, the density of the raisings 11a of the brush roller 11 may preferably be 15 kF/inch² or more from the viewpoint of the collecting performance. On the other hand, the thickness of each raising 11a of the brush roller 11 may preferably be 125 denier or less from the viewpoint of crushing the raisings 11a. Similarly, the density of the raisings 11a of the brush roller 11 may preferably be 60 kF/inch² or less from the viewpoint of the viewpoint of crushing the raisings 11a. That is, in the constitution of this embodiment, the thickness of each raising 11a of the brush roller 11 may preferably be 10 denier or more and 125 denier or less. Further, in the constitution of this embodiment, the density of the raisings 11a of the brush roller 11 may preferably be 15 kF/inch² or more and 60 kF/inch² or less. When the thickness of each raising 11a of the brush roller 11 is larger than 125 denier or when the density of the raisings 11a of the brush roller 11 is higher than 60 kF/inch², it becomes difficult to crush the raisings 11a as described above.

### (3) Mechanism for Improving Transfer Efficiency

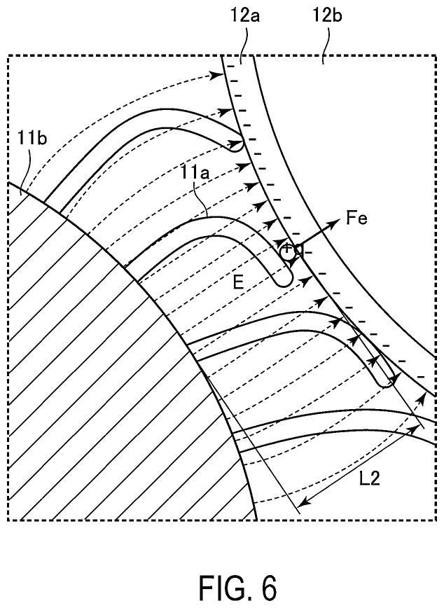

Next, a mechanism for improving the transfer efficiency in the recovering portion R2 will be described. FIG. 6 is a schematic enlarged view of the recovering portion R2 for illustrating an electric field in the recovering portion R2 and a force acting on the paper powder P.

As shown in FIG. 6, in the recovering portion R2, in addition to F_{PET} and F_{PFA} described with reference to FIG. 4, Coulomb force (electrostatic mirror force) Fe is caused to act on the paper powder P by an electric field E generated between the surface layer 12a of the recovering roller 12 and the core portion 11b of the brush roller 11. In the recovering portion R2, on the paper powder P, the Coulomb force Fe acts in a direction from the brush roller 11 side toward the recovering roller 12 side.

That is, the surface of the recovering roller 12 is triboelectrically charged to the negative polarity by slide with the raisings 11a of the brush roller 11 or with the cleaning blade 13. In a steady state after the brush roller 11 and the recovering roller 12 are rotated for several seconds or more, when a surface potential of the recovering roller 12 is measured by a surface electrometer (“Trek P0865”, manufactured by Advanced Energy), the surface electrometer shows-10 kV. The electric field E formed from the core portion 11b of the brush roller 11 toward the surface of the recovering roller 12 is acquired by the following formula: (voltage/distance). In the case where the recovering portion clearance L2 is 7 mm, the electric field is E=−10000 [V]/0.007 [m]=1.4×10⁶ [V/m].

Next, a charge amount possessed by the paper powder P is acquired. The charge amount of the paper powder P in a state in which the paper powder P is deposited on the raisings 11a of the brush roller 11 by being slid with the raisings 11a was measured in the following manner. The paper powder P is sucked by putting an inside of Faraday gage provided with Coulomb meter in a reduced pressure state, so that the paper powder P was collected by a filter provided to the Faraday gage. From a weight M of this collected paper powder P and an electric charge Q directly measured by the Coulomb meter, a charge amount per unit weight (Q/M) was calculated. As the paper powder P, paper powder similar to the above-described paper powder P was used. As a result, the charge amount per unit weight (total charge amount) in the state in which the paper powder P is deposited on the raisings 11a of the brush roller 11 by being slid with the raisings 11a was 1.27 nC/g. When the paper powder P is 20 μm in average diameter and is 2.2 in specific gravity, a charge amount per one particle (triboelectric charge per one particle) q of the paper powder P is 0.012 pC. In a table 1, a calculation result is summarized.

TABLE 1

| | | |
|---|---|---|
| CMMV*¹ | 0.003 | μC |
| EBMV*² | 2.36 | g |
| TCA*³ | 1.27 | nC/g |

| | |
|---|---|
| Specific gravity | 2.2 |
| Diameter | 20 × 10⁻⁶ m |
| Weight | 9211 × 10⁻¹² g |
| TCPOP*⁴ | 0.012 × 10⁻¹² C |

*¹“CMMV” is a Coulomb meter measurement value.
*²“EBMV” is an electrobalance measurement value.
*³“TAC” is the triboelectric charge amount.
*⁴“TCPOP” is the triboelectric charge per one particle.

Therefore, the Coulomb force Fe acting on the paper powder P in the recovering portion R2 is acquired by the following formula 1.

$$Fe = qE \qquad ( formula 1 )$$

In a table 2, in the case where the recovering portion clearance L2 is changed from 10 mm to 3 mm, a value of electric field intensity and the Coulomb force Fe acting on the paper powder P are shown.

TABLE 2

| DT*¹ L2 [mm] | 10 | 8 | 7 | 6 | 5 | 4 | 3 |
|---|---|---|---|---|---|---|---|
| EFI*² [10⁶ V/m] | 1.0 | 1.3 | 1.4 | 1.7 | 2.0 | 2.5 | 3.3 |
| CF*³ Fe [nN] | 12 | 15 | 17 | 20 | 23 | 29 | 39 |

*¹“DT” is the distance.
*²“EFI” is the electric field intensity.
*³“CF” is the Coulomb force,

Part (b) of FIG. 5 is a graph showing a relationship between the recovering portion clearance L2 and the Coulomb force Fe. In part (b) of FIG. 5, an abscissa represents the recovering portion clearance L2, and an ordinate represents the Coulomb force Fe. From part (b) of FIG. 5, it is understood that there is a tendency that the Coulomb force Fe acting on the paper powder P becomes strong with a decreasing recovering portion clearance L2.

With reference to part (a) of FIG. 5, the tendency such that the transfer efficiency in the recovering portion R2 increases with the decreasing recovering portion clearance L2 was described. This would be considered for the following reason. That is, as shown in part (b) of FIG. 5, with the decreasing recovering portion clearance L2, the Coulomb force Fe which is the force other than the electrostatic forces F_{PET} and F_{PFA} acting on the paper powder P in the recovering portion R2 becomes larger. By this, the paper powder P becomes easier to be transferred from the brush roller 11 onto the recovering roller 12.

Thus, the transfer efficiency in the recovering portion R2 can be improved by constituting the core portion 11b of the brush roller 11 with the electric conductor and constituting the surface layer 12a (and further the core portion 12b in this embodiment) of the recovering roller 12 with the insulator, and by making the recovering portion clearance L2 small as can as possible. Part (a) of FIG. 7 is a graph, showing a relationship between the recovering portion clearance L2 and the Coulomb force Fe, similar to the graph of part (a) of FIG. 5 in the case where the recovering portion clearance L2 is further increased. Part (b) of FIG. 7 is a graph showing a range from 0 to 7 mm of the recovering portion clearance L2 in part (a) of FIG. 7 in an enlarged manner. From parts (a) and (b) of FIG. 7, it is understood that the change amount (increasing rate) of the Coulomb force Fe is increased by making the recovering portion clearance L2 not more than 8 mm, preferably not more than 7 mm, particularly not more than 3 mm.

On the other hand, in this embodiment, the collecting portion clearance L1 may desirable be made small as can as possible. That is, in this embodiment, when the collecting portion clearance L1 made small, by an electric field between the core portion 11b formed of the electric conductor and the surface of the photosensitive drum 101 charged to the negative polarity, the Coulomb force Fe in a direction from the brush roller 11 side toward the photosensitive drum 101 side acts on the paper powder P in some instances. Accordingly, in this embodiment, in the collecting portion R1, the collecting portion clearance L1 may desirably be made small as can as possible so that the influence of the Coulomb force Fe, in the direction from the brush roller 11 side toward the photosensitive drum 101 side, acting on the paper powder P is made sufficiently small. From part (a) of FIG. 7, by making the collecting portion clearance L1 not less than 10 mm, it is understood that even in the case where the surface of the photosensitive drum 101 is charged to the negative polarity, an absolute value and a change amount of the Coulomb force Fe become sufficiently small.

Here, the collecting portion clearance L1 can be said as a shortest distance from the core portion 11b, passing through the collecting portion R1, to the surface of the photosensitive drum 101. Further, the recovering portion clearance L2 can be said as a shortest distance from the core portion (core metal) 11b, passing through the recovering portion R2, to the surface layer 12a of the recovering roller 12. At this time, in this embodiment, L1>L2 is satisfied. Further, in this embodiment, the collecting portion clearance L1 may preferably be 10 mm or more, and the recovering portion clearance L2 may preferably be 8 mm or less. That is, in this embodiment, L2/L1<0.8 may preferably be satisfied. However, the collecting portion clearance L1 is set in a range in which the raisings 11a are contactable to the surface of the photosensitive drum 101, and the recovering portion clearance L2 is set in a range in which the raisings 11a are capable of being disposed in the recovering portion R2 from the viewpoint of the crushing amount of the raisings 11a or the like.

Thus, in this embodiment, in the recovering portion R2, by making the recovering portion clearance L2 small (preferably not more than 8 mm, more preferably not more than 7 mm) as can as possible, the transfer efficiency can be improved by utilizing the influence of the Coulomb force Fe (electrostatic mirror force). On the other hand, in this embodiment, in the collecting portion R1, from the viewpoint of the collecting performance, it is desirable that the influence of the Coulomb force Fe (electrostatic mirror force) is made sufficiently small by making the collecting portion clearance L1 large (preferably not less than 10 mm) as can as possible. In this embodiment, a control cycle of the collecting portion clearance L1 and the recovering portion clearance L2 can be realized by a simple constitution by utilizing an elastic force of the raisings 11a of the brush roller 11 while rotating the brush roller 11.

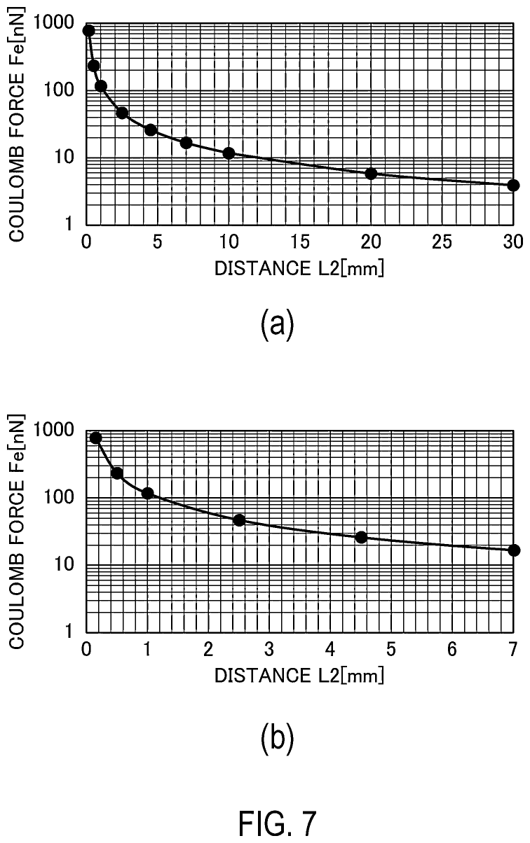

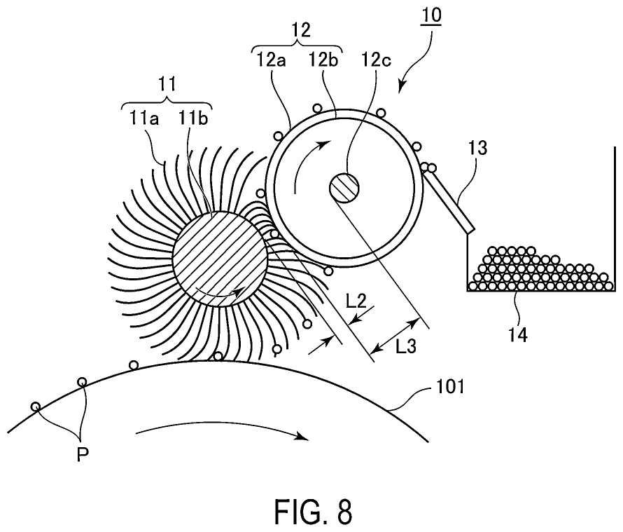

Incidentally, for the purpose of enhancing rigidity of the recovering roller 12, for example, at least in a part, inside the base portion 12b, such as a position including a rotation enter of the recovering roller 12, an electroconductive member formed of the electric conductor such as metal may be provided. In an example of FIG. 8, in a position in the base portion 12b and including the rotation center of the recovering roller 12, a core material 12c formed of an electroconductive metal material as an electric conductor is provided. However, in that case, a distance L3 between the core material 12c of the recovering roller 12 and the surface of the recovering roller 12 may preferably be made larger than the recovering portion clearance L2, particularly made not less than 10 mm. By this, the influence of the Coulomb force Fe acting on the paper powder P in the direction from the recovering roller 12 side toward the brush roller 11 side can be made sufficiently small. Here, the above-described distance L3 can be said as a shortest distance from the core material 12c, passing through the recovering portion R2, to the surface of the recovering roller 12.

Further, in this embodiment, the core portion 11b is connected to the ground potential for the purpose of stabilizing a potential of the core portion 11b of the brush roller 11, but the present invention is not limited thereto. The core portion 11b of the brush roller 11 may also be put in a float state. The charge amount of the surface of the recovering roller 12 is sufficiently small relative to a volume of the core portion 11b of the brush roller 11 formed of the electric conductor and having an outer diameter of 6 mm. For that reason, the core portion 11b of the brush roller 11 is sufficiently large in effect of lowering a potential even when the core portion 11b is not connected to the ground potential, so that a sufficiently large electric field can be generated between itself and the surface of the recovering roller 12.

Further, in this embodiment, the whole of the core portion 11b of the brush roller 11 was formed of the electric conductor, but in at least a part of the recovering portion R2 with respect to a circumferential movement direction of the collecting member (raisings 11a), the electroconductive member formed of the electric conductor may only be required to be provided so as to oppose the recovering member (surface layer 12a) through the collecting member (see embodiments 2 and 3). Further, from the viewpoint of improvement in transfer efficiency in the recovering portion R2, it is preferable that the electroconductive member is provided in a substantially whole area of a region in which the collecting member is provided with respect to a direction (rotational axis direction of the brush roller 11) substantially perpendicular to the circumferential movement direction of the collecting member (raisings 11a). However, for example, the electroconductive member may also be not provided in at least a part of a region such as each of opposite end portions of the collecting member with respect to the direction substantially perpendicular to the circumferential movement direction of the collecting member. Also, in this case, in the region in which the electroconductive member is provided, a corresponding effect similar to the effect of this embodiment.

Further, as a planting method of the raisings 11a in the core portion 11b of the brush roller 11, it is possible to use available arbitrary method. In this embodiment, the brush roller 11 was described as being constituted so that the raisings 11a are directly planted in another peripheral surface of the core portion 11b, but for example, a constitution in which a base cloth (not shown) on which the raisings 11a are provided is wound about and fixed to the outer peripheral surface may also be employed. As this base cloth, it is possible to use woven fabrics formed of fibers identical to or different from the raisings 11a, or the like. However, from the viewpoint such that the recovering portion clearance L2 is made small as can as possible, the thickness of this base cloth may desirably be thin (for example, 0.5 mm or more and 1.5 mm or less) as can as possible. Further, as this base cloth, a base cloth formed of electroconductive fibers may also be used.

Further, the resin material constituting the collecting member such as the raisings of the brush roller is not limited to PET, but may also be for example, another polyester resin, urethane resin, acrylic resin, polyethylene resin, polypropylene resin, or the like. Further, the fluorine-containing resin is not limited to PFA, but may also be for example, PTE (polytetrafluoroethylene), FEP (tetrafluoroethylene-hexafluoropropylene copolymer), ETFE (tetrafluoroethylene-ethylene copolymer), PVDF (polyvinylidene fluoride), PCTFE (polychlorotrifluoroethylene), ECTFE (ethylene-chlorotrifluoroethylene copolymer), or the like.

Thus, in this embodiment, the electrostatic collecting device 10 includes a circumferentially movable collecting member (brush roller raisings) 11a for collecting a substance-to-be-collected (paper powder) P from an object-to-be-cleaned (photosensitive drum) 101, and a circumferentially movable recovering member (recovering roller) 12a for recovering the substance-to-be-collected P from the collecting member 11a. The collecting member 11a is formed of the insulator, and forms the collecting portion R1 in contact with the object-to-be-cleaned 101 and the recovering portion R2 in contact with the recovering member 12a, and electrostatically collects the substance-to-be-collected P from the object-to-be-cleaned 101 in the collecting portion R1 while being circumferentially moved. Further, this electrostatic collecting device 10 includes the electroconductive member (brush roller core portion) 11b which is formed of the electric conductor and which is provided so as to oppose the recovering member 12a positioned in the recovering portion R2 through the collecting member 11a positioned in the recovering portion R2. When a shortest distance from the electroconductive member 11b, passing through the collecting portion R1, to the object-to-be-cleaned 101 is L2 and a shortest distance from the electroconductive member 11b, passing through the recovering portion R2, to the above-described recovering member is L2, L1>L2 is satisfied. Further, L2/L1<0.8 may preferably be satisfied. Further, L2 may preferably be 8 mm or less. In this embodiment, the electrostatic collecting device 10 includes the rotatable collecting body (brush roller) 11 provided with the rotatable core portion 11b and the elastically deformable projections 11a provided on an outer periphery of the core portion 11b, wherein the projections 11a constitute the collecting member and the core portion 11b constitutes the electroconductive member. Particularly, in this embodiment, the projections 11a are constituted by raisings provided on the outer periphery of the core portion 11b. Further, in this embodiment, the electrostatic collecting device 10 includes the rotatable recovering body (recovering roller) 12 with the surface layer 12a, the base portion 12b on which the surface layer 12a is provided at an outer periphery thereof, wherein the surface layer 12a constitutes the recovering member and the base portion 12b is formed of the insulator. Further, in this embodiment, the electrostatic collecting device 10 includes the rotatable recovering body (recovering roller) 12 with the surface layer 12a, the base portion 12b on which the surface layer 12a is provided at an outer periphery thereof, and another electroconductive member (core material) 12e provided opposed to the surface layer 12a positioned in the recovering portion R2 through the base portion 12b, wherein the surface layer 12a constitutes the recovering member and the base portion 12b may be formed of the insulator. In this case, when the shortest distance from the electroconductive member 11b, passing through the recovering portion R2, to the recovering member 12a is L2, and a shortest distance from the another electroconductive member 12c, passing through the recovering portion R2, to the recovering member 12a is L3, L2<L3 may preferably be satisfied. Further, the above-described another electroconductive member 12c may be provided in a position including a rotational axis of the rotatable recovering body 12. Further, in this embodiment, the electroconductive member 11b is electrically grounded. Further, in this embodiment, the electrostatic collecting device 10 collects the paper powder P as the substance-to-be-collected from the surface of the image bearing member 101 as the object-to-be-cleaned in the image forming apparatus 100 in which the image is formed by transferring the toner image, formed on the image bearing member 101, onto the recording material S.

As described above, according to this embodiment, in the cleaning device 10, it is possible to improve the transfer efficiency of the paper powder P from the raisings 11a of the brush roller 11 onto the surface layer 12a of the recovering roller 12. Further, as a result, the collecting performance of the paper powder P by the cleaning device 10 can be maintained at a high level, so that it is possible to suppress an occurrence of an image defect.

### Embodiment 2

Next, another embodiment of the present invention will be described.

Also in this embodiment, similarly as in the embodiment 1, an electrostatic collecting device according to the present invention is used as a cleaning device in an image forming apparatus. In the image forming apparatus and the cleaning device of this embodiment, elements having the same or corresponding functions or constitutions as those of the image forming apparatus and the cleaning device in the embodiment 1 will be appropriately omitted from detailed description by adding thereto the same reference numerals or symbols in the embodiment 1.

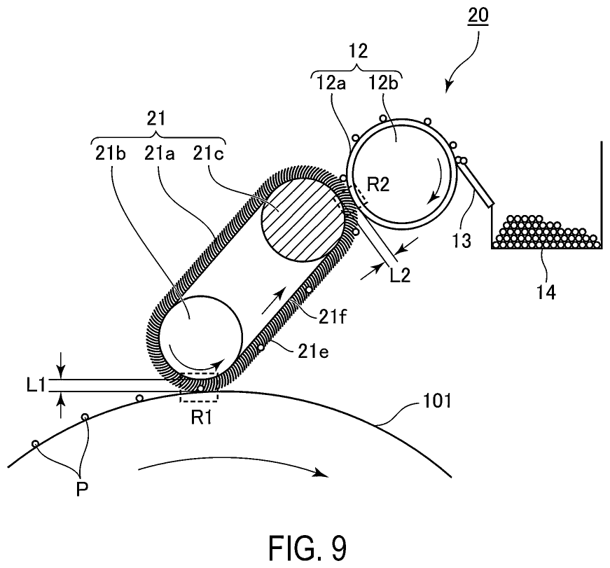

FIG. 9 is a schematic sectional view of a cleaning device 20 of this embodiment (i.e., shows a cross section substantially perpendicular to rotational axis directions of first and second stretching rollers 21b and 21c described later). The cleaning device 20 of this embodiment includes a brush belt unit 21 as a rotatable collecting body in place of the brush roller 11 in the cleaning device 10 of the embodiment 1. In the following, the brush belt unit 21 will be described further specifically.

The brush belt unit 21 includes a brush belt 21a as an elastically deformable portion, and the first stretching roller 21b and the second stretching roller 21c which are as supporting potions for supporting the brush belt 21a. Each of the first stretching roller 21b and the second stretching roller 21c is disposed so that a rotational axis direction thereof and the rotational axis direction of the photosensitive drum 101 are substantially parallel to each other. The brush belt 21a is stretched by two axes of the first stretching roller 21b and the second stretching roller 21c. Each of the first stretching roller 21b and the second stretching roller 21c is rotatably supported by a casing (not shown) of the cleaning device 20 through rotation shaft portions (not shown) provided at opposite end portions thereof with respect to the rotational axis direction thereof. The brush belt 21a is rotated (circumferentially moved) at a peripheral speed of 140 mm/sec in an arrow direction (counterclockwise direction) in FIG. 9 by transmitting a driving force from a motor (not shown), as a driving source constituting a driving means, to the first stretching roller 21b, for example. The first stretching roller 21b is formed of the insulator, and the second stretching roller 21c formed of the electric conductor.

Thus, in this embodiment, of the two stretching rollers for stretching the brush belt 21a, one is formed of the insulator, and the other is formed of the electric conductor.

In this embodiment, the first stretching roller 21b is formed of ABS resin which is an insulating resin material as the insulator. In this embodiment, an outer diameter of the first stretching roller 21b is 10 mm.

Further, in this embodiment, the second stretching roller 21c is formed of aluminum which is an electroconductive metal material as the electric conductor. In this embodiment, the second stretching roller 21c is connected to the ground potential. In this embodiment, an outer diameter of the second stretching roller 21c is 10 mm. Further, in this embodiment, the brush belt 21a which is an endless belt member is constituted by providing raisings 21e, constituting collecting member and each having a natural layer (pile layer) of 2 mm, on a base cloth 12f which is 70 mm in peripheral length and 1 mm in thickness. In this embodiment, the raisings 21e of the brush belt 21a are formed of PET fibers and are 1 denier in thickness and 300 kF/inch² in density. The base cloth 21f may be constituted by, for example, a belt formed of fabric, resin or rubber in the form which is equal to or different from the form of the raisings 21e. Incidentally, the brush belt 21a is not limited to the brush belt stretched by the two axes, but may also be stretched by, for example, three axes, four axes, or the like, i.e., by three or more stretching rollers.

The recovering roller 12, the cleaning blade 13, and the accommodating container 14 in the cleaning device 20 of this embodiment are the same as those in the cleaning device 10 of the embodiment 1, and therefore, will be omitted from description.

Further, in this embodiment, a recovering portion clearance L2 which is a distance between the second stretching roller 21c and the recovering roller 12 is set to 2.5 mm. Accordingly, in this embodiment, in the recovering portion R2, the raisings 21e of the brush belt 21a are contacted to the recovering roller 12 and are bent by 0.5 mm. Thus, in this embodiment, the recovering portion clearance L2 is smaller than the recovering portion clearance L2 in the embodiment 1. By this, Coulomb force Fe acting on the paper powder P in the recovering portion R2 in a direction from a brush belt 21a side toward a recovering roller 12 side can be made large. Accordingly, the transfer efficiency in the recovering portion R2 can be further improved.

On the other hand, in this embodiment, a collecting portion clearance L2 which is a distance between the first stretching roller 21b and the photosensitive drum 101 is set to 2.5 mm. Accordingly, in this embodiment, in the collecting portion R1, the raisings 21e of the brush belt 21a are contacted to the photosensitive drum 101 and bent by 0.5 mm. In this embodiment, a crushing amount of the raisings 21e in the collecting portion R1 is the same as the crushing amount (0.5 mm/2 mm×100=25%) of the raisings 21e in the recovering portion R2. In the embodiment 1, in the collecting portion R1, the core portion 11b of the brush roller 11 which is a member opposing the photosensitive drum 101 was formed of the electric conductor, and therefore, the collecting portion clearance L1 was made not less than 10 mm in order to sufficiently decrease the influence of the Coulomb force Fe. On the other hand, in this embodiment, the first stretching roller 21b which is a member opposing the photosensitive drum 101 in the collecting portion R1 is formed of the insulator. Further, a distance between the second stretching roller 21c formed of the electric conductor and the photosensitive drum 101 is sufficiently long (10 mm or more). For that reason, in this embodiment, there is no need to make the collecting portion clearance L1 large. Thus, in this embodiment, the influence of the Coulomb force Fe acting on the paper powder P in the collecting portion R1 in a direction from the brush belt 21a side toward the photosensitive drum 101 side can be substantially eliminated. Further, in this embodiment, there is no need that the raisings 21e of the brush belt 21a are largely deformed in the collecting portion R1 and the recovering portion R2, and therefore, as the raisings 21e of the brush belt 21a, relatively short fibers can be used in high density. For that reason, on an object-to-be-cleaned, such as the surface of the photosensitive drum 101, with no unevenness and relatively high in smoothness, a substance-to-be-collected, such as talc, relatively small in particle size can be controlled efficiently. In the constitution of this embodiment, from the viewpoint of the collecting performance, a pile length of the raisings 21e of the brush belt 21a may preferably be 1 mm or more and 3 mm or less.

Further, from the viewpoint of the collecting performance, the density of the raisings 21e of the brush belt 21a may preferably be 100 kf/inch². However, from a viewpoint such that the rotation torque of the brush belt 21a does not excessively increase or the like, the density of the raisings 21e of the brush belt 21a may preferably be 500 kF/inch² or less.

Thus, in this embodiment, the electrostatic collecting device 20 includes the rotatable collecting body (brush belt unit) 21 including the circumferentially movable endless belt member (brush belt) 21a provided with the elastically deformable projections (raisings) 21e on the outer periphery thereof, and including a plurality of the stretching rollers 21b and 21c for stretching the belt member 21a. The above-described projections 21e constitutes the collecting member, and of the plurality of the stretching rollers, one stretching roller 21c disposed opposed to the recovering member (recovering roller surface layer) 12a constitutes the electroconductive member. Of the plurality of the stretching rollers, the other stretching roller 21b disposed opposed to the object-to-be-cleaned is formed of the insulator. In this embodiment, the above-described projections 21e is constituted by the raisings provided on the outer periphery of the belt member 21a.

As described above, according to this embodiment, in the cleaning device 20, the transfer efficiency of the paper powder P from the raisings 21e of the brush belt 21a to the surface layer 12a of the recovering roller 12 can be improved. Further, according to this embodiment, on the object-to-be-cleaned with no unevenness and relatively high in smoothness, it is possible to enhance the collecting performance for the substance-to-be-collected relatively small in particle size.

### Embodiment 3

Next, another embodiment of the present invention will be described. Also in this embodiment, similarly as in the embodiment 1, an electrostatic collecting device according to the present invention is used as a cleaning device in an image forming apparatus. In the image forming apparatus and the cleaning device of this embodiment, elements having the same or corresponding functions or constitutions as those of the image forming apparatus and the cleaning device in the embodiment 1 will be appropriately omitted from detailed description by adding thereto the same reference numerals or symbols in the embodiment 1.

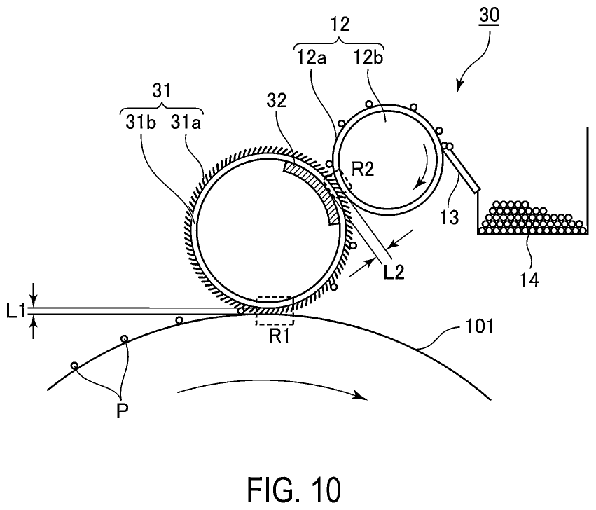

FIG. 10 is a schematic sectional view of a cleaning device 30 of this embodiment (i.e., shows a cross section substantially perpendicular to a rotational axis direction of a hollow brush roller 31 described later). The cleaning device 30 of this embodiment includes the hollow brush roller 31 as a rotatable collecting body in place of the brush roller 11 in the cleaning device 10 of the embodiment 1, and in a hollow portion of the hollow brush roller 31, an opposing member 32 formed of an electric conductor is provided. In the following, the brush belt unit 21 will be described further specifically.

The hollow brush roller 31 includes raisings 31a as an elastically deformable portion constituting a collecting member and a cylindrical portion 31b as a supporting portion for supporting this raisings 31a. The cylindrical portion 31b of the hollow brush roller 31 is a cylindrical member formed of ABS resin which is an insulating resin material as an insulator, and is disposed opposed to the photosensitive drum 101 so that a rotational axis direction thereof is substantially parallel to the rotational axis direction of the photosensitive drum 101. The cylindrical portion 31b of the hollow brush roller 31 is rotatably supported by a casing (not shown) of the cleaning device 10 through a rotation shaft portion provided at each of opposite end portions thereof with respect to the rotational axis direction thereof. In this embodiment, a thickness of the cylindrical portion 31b of the hollow brush roller 31 is 2 mm. Further, an outer diameter of the cylindrical portion 31b of the hollow brush roller 31 is 22 mm, for example. On an outer peripheral surface of the cylindrical portion 31b of the hollow brush roller 31, the raisings 31a of the hollow brush roller 31 are provided. The free length (pile length), the thickness, and the density of the raisings 31a of the hollow brush roller 31 are the same as those in the embodiment 2. In this embodiment, the hollow brush roller 31 is constituted by winding a base cloth (not shown), provided with the raisings 31a similarly as in the base cloth in the embodiment 2, about the outer peripheral surface of the cylindrical portion 31b and then by fixing the base cloth to the outer peripheral surface of the cylindrical portion 31b. That is, in this embodiment, similarly as in the embodiment 2, the free length of the raisings 31a is 2 mm, and the thickness of the base cloth is 1 mm.

Inside the hollow portion 31c in the cylindrical portion 31b of the hollow brush roller 31, the opposing member 32 formed of SUS (stainless steel) which is an electroconductive metal material as the electric conductor is provided. The opposing member 32 is disposed along an inner peripheral surface of the cylindrical portion 31b so as to oppose the surface layer 12a of the recovering roller 12 through the raisings 31a in a region including at least a part of the recovering portion R2 with respect to a rotational direction of the hollow brush roller 31. Particularly, in this embodiment, the opposing member 32 is disposed along the inner peripheral surface of the cylindrical portion 31b in a range of about 60 degrees with a rotation center, as a center, of the hollow brush roller 31 so as to include a substantially whole area of the recovering portion R2 with respect to the rotational direction of the hollow brush roller 31. The region in which the opposing member 32 is disposed includes a closest position between itself and the recovering roller 12 at the inner peripheral surface of the cylindrical portion 31b. In this embodiment, the opposing member 32 is constituted by an arcuate member of 2 mm in thickness. Further, in this embodiment, the opposing member 32 is disposed in a fixed state so as to contact the number peripheral surface of the cylindrical portion 31b. Further, in this embodiment, the opposing member 32 is provided in a substantially whole area of the region in which the raisings 31a are provided with respect to the rotational axis direction of the hollow brush roller 31. Further, in this embodiment, the opposing member 32 is connected to the ground potential. Incidentally, the opposing member 32 may be disposed with an interval between itself and the inner peripheral surface of the cylindrical portion 31b.

The recovering roller 12, the cleaning blade 13, and the accommodating container 14 in the cleaning device 30 of this embodiment are the same as those in the cleaning device 10 of the embodiment 1, and therefore, will be omitted from description.

Further, in this embodiment, a distance between the outer peripheral surface of the cylindrical portion 31b of the hollow brush roller 31 and the recovering roller 12 (2.5 mm) is the same as the distance between the outer peripheral surface of the second stretching roller 21c in the embodiment 2. Accordingly, in this embodiment, a recovering portion clearance L2 which is a distance between the opposing member 32 and the recovering roller 12 is set to 4.5 mm. Further, in this embodiment, in the recovering portion R2, the raisings 31a of the hollow brush roller 31 are contacted to the recovering roller 12 and are bent by 0.5 mm. Further, a collecting portion clearance L1 which is a distance between the outer peripheral surface of the cylindrical portion 31b of the hollow brush roller 31 in this embodiment and the photosensitive drum 101 is set to 2.5 mm which is the same as the collecting portion clearance L1 in the embodiment 2. Accordingly, in this embodiment, in the collecting portion R1, the raisings 31a of the hollow brush roller 31 are contacted to the photosensitive drum 101 and bent by 0.5 mm.

Also, in the constitution of this embodiment, similarly as the constitution of the embodiment 2, by making the collecting portion clearance L2 small, it is possible to realize the high transfer efficiency in the recovering portion R2. Further, also in the constitution of this embodiment, similarly as the constitution of the embodiment 2, in the collecting portion R1, a distance between the opposing member 32 formed of the electric conductor and the photosensitive drum 101 is sufficiently long (10 mm or more). For that reason, also the constitution of this embodiment, similarly as the constitution of the embodiment 2, there is no need to make the collecting portion clearance L1 large. Thus, in this embodiment, the influence of the Coulomb force Fe acting on the paper powder P in the collecting portion R1 in a direction from the hollow brush roller 31 side toward the photosensitive drum 101 side can be substantially eliminated. Further, also in the constitution of this embodiment, similarly as the constitution of the embodiment 2, it is possible to enhance the collecting performance for the substance-to-be-collected relatively small in particle size on the object-to-be-cleaned with no unevenness and relatively high in smoothness.

Further, according to this embodiment, compared with the constitution of the embodiment 2 in which the belt is stretched by the two axes, the number of component parts is reduced, so that a more compact constitution can be realized.

Thus, in this embodiment, the electrostatic collecting device 30 includes the rotatable collecting body (hollow brush roller) 31 provided with the rotatable cylindrical member (cylindrical portion) 31b formed of the insulator and with the elastically deformable projections (raisings) 31a provided on the outer periphery of the cylindrical member 31b. The projections 31a constitute the collecting member, and the electroconductive member (opposing member) 32 is fixedly disposed in the hollow portion of the cylindrical member 31b along at least a part of the inner peripheral surface of the cylindrical member 31b so as to oppose the recovering member 12a positioned in the recovering portion R2 through the projections 31a positioned in the recovering portion R2. In this embodiment, the above-described projections 31a are constituted by the raisings provided on the outer periphery of the cylindrical member 31b.

As described above, according to this embodiment, an effect similar to the effect of the embodiment 2, and in addition, it is possible to realize simplification of the device constitution and downsizing of the electrostatic collecting device.

### Embodiment 4

Next, another embodiment of the present invention will be described. In this embodiment, an electrostatic collecting device according to the present invention is different in purpose from the embodiments 1 to 3. In this embodiment, the electrostatic collecting device according to the present invention is used as a cleaning device (cleaner, manual cleaner) for cleaning a floor surface. In the cleaning device of this embodiment, elements having the same or corresponding functions or constitutions as those of the cleaning device in the embodiment 1 will be appropriately omitted from detailed description by adding thereto the same reference numerals or symbols in the embodiment 1.

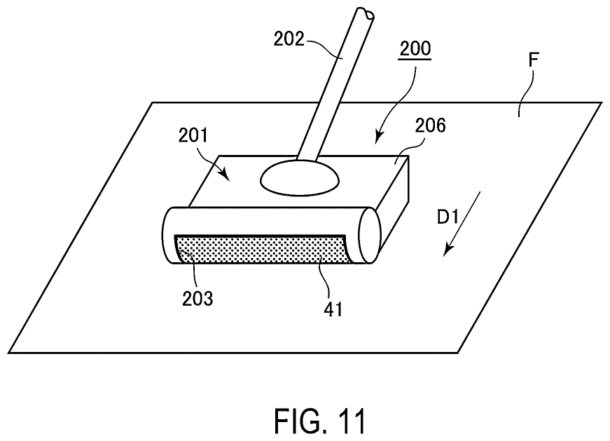

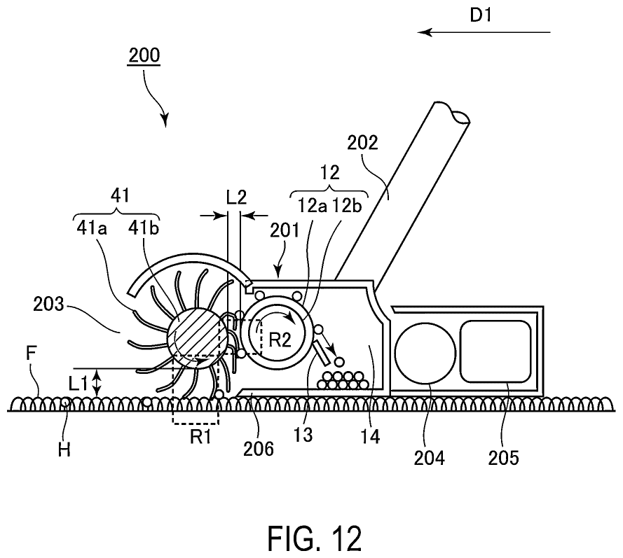

FIG. 11 is a schematic perspective view of an outer appearance of a cleaning device (cleaning apparatus) 200 of this embodiment. In this embodiment, an object-to-be-cleaned of the cleaning device 200 is principally a floor surface (particularly a carpet) F, and a substance-to-be-collected is dust (dirt) H or the like existing on the floor surface F (hereinafter, simply referred to as “dust”) (FIG. 12).

The cleaning device 200 includes an apparatus main assembly 201 and a handle 202 connected to the apparatus main assembly 201. A user holds the handle 202 and can clean the floor surface F while pushing formed the apparatus main assembly 201, placed on the floor surface F, in an arrow D1 direction in FIG. 11. Incidentally, the cleaning device 200 can clean the floor surface F also when pulls the apparatus main assembly 201 back in a direction opposite to the arrow D1 direction in FIG. 11, for example. However, in this embodiment, it is assumed that the floor surface F is cleaned while pushing forward the apparatus main assembly 201 principally in the arrow D1 direction in FIG. 11, a mounting position and a movable range of the handle 202 relative to the apparatus main assembly 201 are set. Here, the arrow D1 direction in FIG. 11 is also referred to as a “cleaning direction D1”. In a front portion of a casing 206 of the apparatus main assembly 201 in the cleaning direction D1, an opening 203 for taking the dust H inside the casing 206 is provided.

FIG. 12 is a schematic sectional view of the cleaning device 200 of this embodiment (i.e., shows a cross section substantially perpendicular to rotational axis directions of a paddle roller 41 described later). A principle of a layer operation by the cleaning device 200 is similar to the principle by the cleaning device 10 in the embodiment 1. In this embodiment, the cleaning device 200 of this embodiment includes the paddle roller 41 in place of the brush roller 11 in the cleaning device 10 of the embodiment 1. In the following, the brush belt unit 21 will be described further specifically.

The apparatus main assembly 201 of the cleaning device (cleaning apparatus) 200 includes the paddle roller 41 as a rotatable collecting body, a recovering roller 12 as a rotatable recovering body, a cleaning blade 13 as a removing member (scraping-off member), an accommodating container (accommodating portion) 14, a motor 204 as a driving source constituting a driving means, a battery 205 for supplying electric power to the motor 204 or the like, and the casing 206 for accommodating these parts inside thereof. The paddle roller 41 collects, by rotation thereof, the dust H on the floor surface F in a manner such that the dust H is scraped (taken) inside the casing 206 through the opening 203 provided in the casing 206.

The paddle roller 41 includes paddles (elastically deformable projections) 41a as an elastically deformable portion constituting the collecting member and a core portion (core metal) 41b as a supporting portion for supporting the paddle 41a. The core portion 41b of the paddle roller 41 is constituted by a cylindrical member, and is disposed opposed to the floor surface F so that a rotational axis direction of the core portion 41b is substantially parallel to and crosses (typically is substantially perpendicular to) the floor surface F in a state in which the apparatus main assembly 201 is placed on the floor surface F. The core portion 41b of the paddle roller 41 is supported rotatably by the casing 206 of the cleaning device 200 through a rotation shaft (not shown) provided at each of opposite end portions thereof with respect to the rotational axis direction thereof. On an outer peripheral surface of the core portion 41b of the paddle roller 41, along the rotational axis direction of the core portion 41b, a plurality of paddles 41a are provided. The paddles 41a are provided substantially equidistantly along a circumferential direction of the core portion 41b and radially from the core portion 41b. In this embodiment, the paddle roller 41 is provided with 14 paddles 41a. However, the number of the paddles 41a is not limited thereto, but can be appropriately set from the viewpoint of the collecting performance. The number of the paddles 41 may suitably be, for example, 3 or more and 20 or less. Each of the paddles 41a is a substantially rectangular sheet-like member, in plan view, having a predetermined length and a predetermined thickness with respect to each of a longitudinal (long-side) direction substantially parallel to the rotational axis direction of the core portion 41b and a widthwise (short-side) direction perpendicular to the longitudinal direction. A length of the paddle (sheet) 41a in the longitudinal direction is the same as the length of the core portion 41b with respect to the rotational axis direction (for example, about 200−300 mm). In this embodiment, the paddle roller 41 is constituted by being fixed by nipping one end portion of the paddle 41a with respect to the widthwise direction in a groove formed substantially parallel to the rotational axis direction of the core portion 41b on an outer peripheral surface of the core portion 41b.

In this embodiment, the core portion 41b of the paddle roller 41 is formed of aluminum which is an electroconductive metal material as an electric conductor. Further, in this embodiment, the core portion 41b of the paddle roller 41 is connected to the ground potential. The paddle 41a is formed of the insulator. As a material of the paddle 41a, a material on a side negative relative to the substance-to-be-collected and positive relative to the surface layer 12a of the recovering roller 12 in terms of the position in the triboelectric charge series. That is, as described above, when substances different in the position of the triboelectric charge series are rubbed with each other, electric charges are exchanged between the two substances, so that one is charged to the positive polarity and the other one is charged to the negative polarity. Further, in general, there is a tendency that the substances are charged strongly with a remoter positional relationship in the triboelectric charge series. Further, in general, in many cases, the dust H includes dust, on the side positive in position in the triboelectric charge series, such as various fibers inclusive of cotton dust generated from clothes or the like, human dandruff and sebum, dung and cadavers of mites, and the like. As the material of the paddle 41a, it is desirable that a material of which position in the triboelectric charge series is remote from the dust H on the negative side and is on the positive side relative to the material of the surface layer 12a of the recovering roller 12. For that reason, in this embodiment, the paddle 41a is formed of PET.

The recovering roller 12, the cleaning blade 13, and the accommodating container 14 in the cleaning device 200 of this embodiment are similar to those of the cleaning device 10 of the embodiment 1, and thus are omitted from description.

The paddle roller 41 is provided so as to be exposed to an outside of the casing 206 from the opening 202 provided in the casing 206 of the apparatus main assembly 201, and on a rear side thereof, the recovering roller 12, the cleaning blade 13, and the accommodating container 14 are provided. To the paddle roller 41, a driving force from the motor 204 is transmitted by a drive transmitting member (not shown), so that the paddle roller 41 is rotated at a peripheral speed of, for example, 140 mm/sec in an arrow direction (counterclockwise direction) in FIG. 12. To the motor 204, electric power is supplied from the battery 205. A natural length (length in widthwise direction) of the paddle 41a and a collecting portion clearance L1 are set as described above, so that the paddle roller 41 is rotated while the paddles 41a contact the floor surface F. The user collects the dust H, disposed on the floor surface F, by the paddle roller 41 while pushing forward the apparatus main assembly 201 in the cleaning direction D1. In this embodiment, the paddle roller 41 is rotated so that in a collecting portion R1 where the paddles 41a and the floor surface F are in contact with each other, a movement direction of the paddles 41a and a relative movement direction (opposite direction to the cleaning direction D1) of the floor surface F relative to the apparatus main assembly 201 are the same direction (forward direction). In the collecting portion R1, when the paddles 41a of the rotating paddle roller 41 and the dust H on the floor surface F are rubbed with each other, the paddles 41a are charged to the negative polarity, and the dust H is charged to the positive polarity. As a result, the paddles 41a are increased in potential on the negative side compared with the floor surface F, so that the dust H can be collected from the floor surface F. The dust H collected by the paddle roller 41 is transferred onto the recovering roller 12 in the recovering portion R2 where the paddles 41a and the recovering roller 12 are in contact with each other, and then is scraped off from the recovering roller 12 by the cleaning blade 13 and is accommodated in the accommodating container 14. Incidentally, the rotational direction and the peripheral speed of the paddle roller 41 are not limited to those in this embodiment. The paddle roller 41 may be rotated so that in the collecting portion R1, the movement direction of the paddles 41a and the relative movement direction (opposite direction to the cleaning direction D1) of the floor surface F to the apparatus main assembly 201 are opposite directions to each other. Further, the peripheral speed of the paddle roller 41 may be made faster or slower than the peripheral speed in this embodiment.

In this embodiment, an outer diameter of the core portion 41b of the paddle roller 41 is 6 mm, the natural length (length in the widthwise direction) of the paddles 41a is 11 mm, and an outer diameter of the paddle roller 41 is 28 mm. Incidentally, the natural length of the paddles 41a is a length not in the case where the paddles 41a are deformed under application of pressure by the floor surface F and the recovering roller 12. Further, the outer diameter (diameter) of the paddle roller 41 is a diameter of a circumscribed circle of the paddles 41a in a natural state. Further, in this embodiment, the paddles 41a are formed with a PET sheet of 150 μm in thickness.

Further, in this embodiment, a recovering portion clearance L2 which is a distance between the core portion 41b of the paddle roller 41 and the recovering roller 12 is set to 3 mm. Accordingly, in this embodiment, in the recovering portion R2, the paddles 41a are contacted to the recovering roller 12 and are bent by 8 mm. By this, Coulomb force Fe acting on the dust H in a direction from a paddle roller 41 side toward a recovering roller 12 side is made large, so that transfer efficiency of the dust H in the recovering portion R2 can be improved.

On the other hand, in this embodiment, a collecting portion clearance L1 which is a distance between the core portion 41b of the paddle roller 41 and the floor surface F is regulated by a bottom of the casing 206 and is set to 10 mm. That is, in this embodiment, a distance between the core portion 41b of the paddle roller 41 and a plane formed by the bottom of the casing 206 placed on the floor surface F is the collecting portion clearance L1. Incidentally, to the casing 206, a member placed on the floor surface F, such as wheels may be provided. In that case, a distance between the core portion 41b of the paddle roller 41 and a plane formed by a contact portion of the wheels with the floor surface F is the collecting portion clearance L1. The collecting portion clearance L1 is thus set, so that even in the case where the floor surface F is charged to the negative potential, the influence of the Coulomb force Fe acting on the dust H in the collecting portion R1 in a direction from a paddle roller 41 side toward a floor surface F side can be made sufficiently small.

Here, the paddles 41a may preferably be bent in the recovering portion R2 and are returned to an original shape by an elastic force when the pressure application in the recovering portion R2 is released. From this viewpoint, a thickness of the paddles 41a may preferably be 75 μm or more and 250 μm or less.

Further, the floor surface F as the object-to-be-cleaned is a carpet, for example, and the dust H enters piles of the carpet in some instances. In this embodiment, the paddles 41a are capable of tapping the floor surface F with an elastic force stronger than the elastic force of the raisings 11a of the brush roller 11 in the embodiment 1. By this, for example, as in the case where the floor surface F is the carpet, even in a situation with that the dust H is embedded in fibers (piles), the dust H in the fibers can be collected by being tapped by the paddles 41a.

Thus, in this embodiment, the electrostatic collecting device 200 includes the rotatable collecting body (paddle roller) 41 provided with the rotatable core portion 41b and the elastically deformable projections (paddles) 41a provided on the outer periphery of the core portion 41b, in which the projections 41a constitute the collecting member and the core portion 41b constitutes the electroconductive member. Particularly, in this embodiment, the projections 41a are constituted by sheets provided on the outer periphery of the core portion 41b along the rotational axis direction of the core portion 41b. Further, in this embodiment, the electrostatic collecting device 200 collects the dust H as the substance-to-be-collected from the object-to-be-cleaned.

As described above, according to this embodiment, in the cleaning device 200, the transfer efficiency of the dust H from the paddles 41a of the paddle roller 41 onto the surface layer 12a of the recovering roller 12 can be improved.

### Embodiment 5

Next, another embodiment of the present invention will be described. Also in this embodiment, similarly as in the embodiment 4, an electrostatic collecting device according to the present invention is used as a cleaning device (cleaner, manual cleaner) for cleaning a floor surface. In the cleaning device of this embodiment, elements having the same or corresponding functions or constitutions as those of the cleaning device in the embodiment 4 will be appropriately omitted from detailed description by adding thereto the same reference numerals or symbols in the embodiment 4.

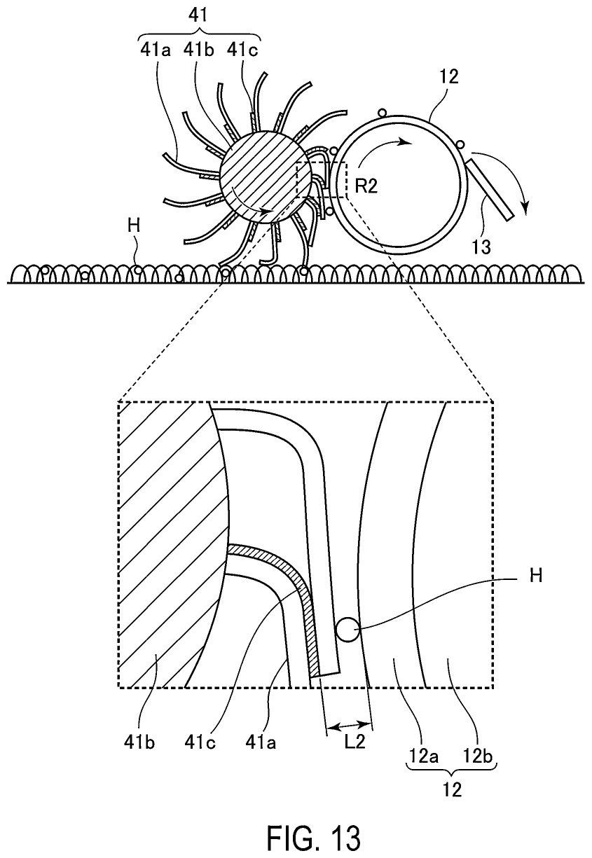

FIG. 13 is a schematic sectional view of a neighborhood of a paddle roller 41 and a recovering roller 12 in a cleaning device 200 of this embodiment (i.e., shows a cross section substantially perpendicular to rotational axis directions of the paddle roller 41). The cleaning device 200 of this embodiment includes an electroconductive sheet 41c provided on a surface of each paddle 41a in addition to the constitution of the cleaning device 200 of the embodiment 4. In the following, the brush belt unit 21 will be described further specifically.

The paddle roller 41 includes the paddles 41a and the core portion 41b. Constitutions of the paddles 41a and the core portion 41b of the paddle roller 41 in this embodiment are the same as those in the embodiment 4. That is, the paddles 41a of 11 mm in natural length (length in the widthwise direction) are mounted on the outer peripheral surface of the core portion 11b of 6 mm in outer diameter, and each of the paddles 41a is formed of the PET sheet of 150 μm in thickness.

Further, in this embodiment, on a side surface of each paddle 41a on a downstream side of the rotational direction of the paddle roller 41. The electroconductive sheet 41c formed of aluminum which is an electroconductive metal material as the electric conductor is disposed. The electroconductive sheet 41c is provided over a whole area of the paddle 41a with respect to the longitudinal direction from a base end portion which is an end portion on the core portion 41b side with respect to the widthwise direction of the paddle 41a, in a predetermined range on a free end portion side which is an end portion opposite from the core portion 41b. In this embodiment, the electroconductive sheet 41c is formed with an aluminum sheet of 0.05 mm in thickness. A base end portion, which is an end portion on the core portion 41b side with respect to the widthwise direction, of the electroconductive sheet 41c extending along the widthwise direction of the paddle 41a contacts the core portion 41b. By this, the electroconductive sheet 41c is electrically conducted to the core portion 41b. In this embodiment, the base end portion of the electroconductive sheet 41c are fixed together with the base end portion of the paddle roller 41 by being nipped in a groove formed on the outer peripheral surface of the core portion 41b. The length of the electroconductive sheet 41c in the widthwise direction can be appropriately set from viewpoints of improving the collecting performance by the paddles 41a in the collecting portion R2 and the transfer efficiency in a recovering portion R2 described later. However, the length of the electroconductive sheet 41c in the widthwise direction may preferably be shorter than a length of the paddle 41a in the widthwise direction and not more than half of the length of the paddle 41a in the widthwise direction. Further, the length of the paddle 41a in the widthwise direction is longer than a distance between the core portion 41b and the recovering roller 12. Particularly, when the paddle 41a is contacted to the recovering roller 12 in the recovering portion R2 and is bent, the electroconductive sheet 41c may preferably overlap with at least a part of a region of the paddle 41a provided, on a free end side in the widthwise direction, adjacently on a downstream side with respect to the rotational direction of the paddle roller 41.

In this embodiment, the length of the electroconductive sheet 41c in the widthwise direction is 5 mm. Further, in this embodiment, the electroconductive sheet 41c is fixed to the side surface of the paddle 41a with a double-sided tape, and is circumferentially moved while being deformed together with the paddle 41a. Incidentally, fixing of the electroconductive sheet 41c to the side surface of the paddle 41a is not limited to fixing with the double-sided tape, but it is possible to use an arbitrary fixing means such as bonding, welding, or the like. Further, the electroconductive sheet 41c may also be disposed so as to extend along the side surface of the paddle 41a without being fixed to the side surface of the paddle 41a.

The recovering roller 12, the cleaning blade 13, and the accommodating container 14 in the cleaning device 200 of this embodiment are the same as those of the cleaning device 200 of the embodiment 4, so that description thereof will be omitted.

Action of the electroconductive sheet 41c will be described. As shown in FIG. 13 in an enlarged manner, in the recovering portion R2, the paddle 41a pressed and bent by the recovering roller 12 is sandwiched between the electroconductive sheet 41c and the recovering roller 12. In this embodiment, the electroconductive sheet 41c provided adjacent to one paddle 41a is sandwiched between a part of the side surface of the one paddle 41a on the base end portion side of the one paddle 41a and a part of the side surface of another paddle 41a, provided downstream of and adjacent to the one paddle 41a with respect to the rotational direction, on the free end side of the another paddle 41a. By this, the recovering portion clearance L2 in which the Coulomb force Fe acting on the dust H deposited on the paddle 41a is generated can be made small. That is, in this embodiment, the recovering portion clearance L2 for generating the Coulomb force Fe is a distance between the electroconductive sheet 41c and the recovering roller 12. In the constitution of the embodiment 4, the recovering portion clearance L2 was 3 mm. On the other hand, in the constitution of this embodiment, the recovering portion clearance L2 can be made small to a distance which is roughly the sum of the thickness (150 μm) of the paddle 41a and a distance (200 μm or less in general) between the paddle 41a and the recovering roller 12 between which the dust H is sandwiched.

Part (b) of FIG. 7 shows a relationship between the recovering portion clearance L2 and the Coulomb force Fe (formula 1) in a region in which the recovering portion clearance L2 is 7 mm or less. As is understood from part (b) of FIG. 7, a change amount (increasing rate) of the Coulomb force Fe becomes larger with a smaller recovering portion clearance L2, and in the case where the recovering portion clearance L2 is 0.15 μm, the Coulomb force Fe becomes close to 1000 [nN]. By this, the transfer efficiency of the dust H in the recovering portion R2 can be made drastically high.

Incidentally, in this embodiment, the electroconductive sheet 41c was provided in the substantially whole area of the paddle 41a with respect to the longitudinal direction, but for the electroconductive sheet 41c may also be not provided at least in a part of a region, such as opposite end portions of the paddle 41a with respect to the longitudinal direction. Also, in this case, in a region in which the electroconductive sheet 41c is provided, a corresponding effect similar to the effect of this embodiment can be obtained. Further, in this embodiment, the electroconductive sheet 41c was provided to all the paddles 41a of the paddle roller 41, but is provided to at least a part of the paddles 41a, so that a corresponding effect similar to the effect of this embodiment can be obtained.

Thus, in this embodiment, the rotatable collecting body (paddle roller) 41 includes the electroconductive sheet 41c which is provided on the core portion 41b, adjacent to the sheet (paddle) 41a, along the rotational axis direction of the core portion 41b and which is formed of the electric conductor. In this embodiment, the electroconductive sheet 41c is electrically conducted to the core portion 41b. Further, in this embodiment, the electroconductive sheet 41c is fixed to the side surface of the sheet 41a and is deformed together with the sheet 41a. Further, in this embodiment, the electroconductive sheet 41c is provided so as to be sandwiched between two sheets 41a which are deformed by the recovering member (surface layer of the recovering roller) 12 in the recovering portion R2 and which are adjacent to each other. Further, in this embodiment, the length of the electroconductive sheet 41c in the widthwise direction perpendicular to the longitudinal direction along the rotational axis direction of the core portion 41b is shorter than the length of the sheet 41a in the widthwise direction. Further, the length of the electroconductive sheet 41c in the widthwise direction may preferably be not more than half of the length of the sheet 41a in the widthwise direction.

As described above, according to this embodiment, the transfer efficiency of the dust H from the paddles 41a of the paddle roller 41 onto the surface layer 12a of the recovering roller 12 can be improved more than the transfer efficiency in the constitution of the embodiment 4.

### Embodiment 6

Next, another embodiment of the present invention will be described. In this embodiment, the electrostatic collecting device according to the present invention is used as a handheld cleaning device (cleaner, handheld cleaner) for cleaning a wall surface, top of a desk, a surface of a display, and the like and designed light-weighted. In the cleaning device of this embodiment, elements having the same or corresponding functions or constitutions as those of the cleaning device in the embodiment 1 will be appropriately omitted from detailed description by adding thereto the same reference numerals or symbols in the embodiment 1.

FIG. 12 is a schematic sectional view of the cleaning device 300 of this embodiment (i.e., shows a cross section substantially perpendicular to rotational axis directions of a brush roller 11 described later). A principle of a layer operation by the cleaning device 300 is similar to the principle by the cleaning device 10 in the embodiment 1. In this embodiment, an object-to-be-cleaned of the cleaning device is a surface-to-be-cleaned G such as the wall surface, the top of the desk, the surface of the display, and the like, and a substance-to-be-collected is dust H existing on the surface-to-be-cleaned G.

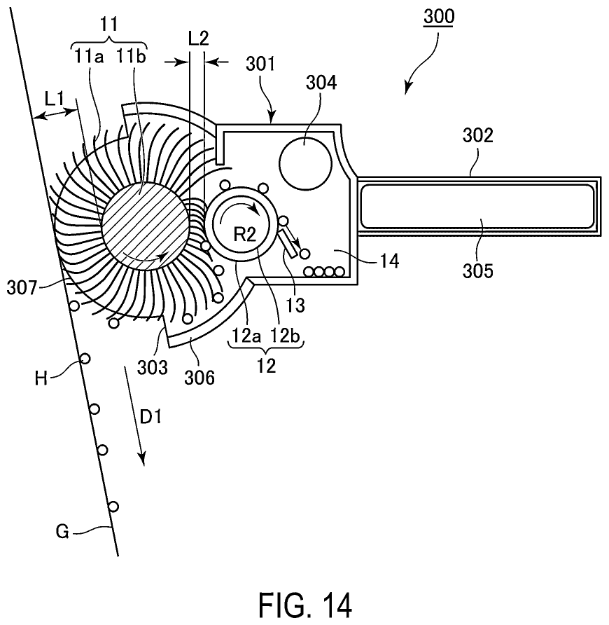

The cleaning device 300 includes an apparatus main assembly 301 and a handle 302 connected to the apparatus main assembly 301. A user holds the handle 302 and can clean the surface-to-be-cleaned G by moving the apparatus main assembly 301, contacted to the surface-to-be-cleaned G so as to brush the surface-to-be-cleaned gently, in an arrow D1 direction in FIG. 14. Incidentally, the cleaning device 300 can clean the floor surface F also when moves the apparatus main assembly 301 in a direction opposite to the arrow D1 direction in FIG. 14, for example. However, in this embodiment, it is principally assumed that the surface-to-be-cleaned G is cleaned while moving the apparatus main assembly 301 in the arrow D1 direction in FIG. 14, a position and a shape of the handle 302 relative to the apparatus main assembly 301 are set. Here, the arrow D1 direction in FIG. 14 is also referred to as a “cleaning direction D1”.

The apparatus main assembly 301 of the cleaning device (cleaning apparatus) 300 includes the brush roller 11 as a rotatable collecting body, a cleaning blade 13 as a removing member (scraping-off member), an accommodating container (accommodating portion) 14, a motor 304 as a driving source constituting a driving means, and the casing 306 for accommodating these parts inside thereof. Further, inside the handle 302, a battery 305 for supplying electric power to the motor 304 or the like, is accommodated. The brush roller 11 collects the dust H on the surface-to-be-cleaned G in a manner such that the dust H is scraped (taken) inside the casing 306 through the opening 303 provided in the casing 306.

The brush roller 11, the recovering roller 12, the cleaning blade 13, and the accommodating container 14 in the cleaning device 300 of this embodiment are similar to those of the cleaning device 10 of the embodiment 1, and thus are omitted from description.

The brush roller 11 is provided so as to be exposed to an outside of the casing 306 from the opening 302 provided in the casing 306 of the apparatus main assembly 301, and on a rear side thereof, the recovering roller 12, the cleaning blade 13, and the accommodating container 14 are provided. To the brush roller 11, a driving force from the motor 304 is transmitted by a drive transmitting member (not shown), so that the paddle roller 41 is rotated at a peripheral speed of, for example, 140 mm/sec in an arrow direction (counterclockwise direction) in FIG. 14. To the motor 304, electric power is supplied from the battery 305. A natural length (pile length) of the paddle 11a of the brush roller 11 and a collecting portion clearance L1 are set as described above, so that the brush roller 11 is rotated while the paddles 11a contact the surface-to-be-cleaned G. The user collects the dust H, disposed on the floor surface F, by the brush roller 11 while moving the apparatus main assembly 301 in the cleaning direction D1. In this embodiment, the brush roller 11 is rotated so that in a collecting portion R1 where the raisings 11a of the brush roller 11 and the surface-to-be-cleaned G are in contact with each other, a movement direction of the raisings 11a and a relative movement direction (opposite direction to the cleaning direction D1) of the surface-to-be-cleaned G relative to the apparatus main assembly 301 are opposite directions. In the collecting portion R1, when the raisings 11a of the rotating brush roller 11 and the dust H on the surface-to-be-cleaned G are rubbed with each other, the raisings 11a are charged to the negative polarity, and the dust H is charged to the positive polarity. As a result, the raisings 11a are increased in potential on the negative side compared with the surface-to-be-cleaned G, so that the dust H can be collected from the surface-to-be-cleaned G. The dust H collected by the brush roller 11 is transferred onto the recovering roller 12 in the recovering portion R2 where the raisings 11a of the brush roller 11 and the recovering roller 12 are in contact with each other, and then is scraped off from the recovering roller 12 by the cleaning blade 13 and is accommodated in the accommodating container 14. Incidentally, the rotational direction and the peripheral speed of the brush roller 11 are not limited to those in this embodiment. The brush roller 11 may be rotated so that in the collecting portion R1, the movement direction of the raisings 11a and the relative movement direction (opposite direction to the cleaning direction D1) of the surface-to-be-cleaned G to the apparatus main assembly 301 are opposite directions to each other. Further, the peripheral speed of the brush roller 11 may be made faster or slower than the peripheral speed in this embodiment.

In this embodiment, an outer diameter of the core portion 11b of the brush roller 11 is 6 mm, the natural length of the raisings 11a is 11 mm, and an outer diameter of the brush roller 11 is 28 mm. Further, in this embodiment, a recovering portion clearance L2 which is a distance between the core portion 11b of the brush roller 11 and the recovering roller 12 is set to 7 mm. Accordingly, in this embodiment, in the recovering portion R2, the raisings 11a of the brush roller 11 are contacted to the recovering roller 12 and are bent by 4 mm. By this, Coulomb force Fe acting on the dust H in a direction from a brush roller 11 side toward a recovering roller 12 side is made large, so that transfer efficiency of the dust H in the recovering portion R2 can be improved.

On the other hand, in this embodiment, a collecting portion clearance L1 which is a distance between the core portion 11b of the brush roller 11 and the surface-to-be-cleaned G is regulated by an abutting portion 307 as a regulating portion provided on the casing 306 and is set to 10 mm. By this, even in the case where the surface-to-be-cleaned G is charged to the negative potential, the influence of the Coulomb force Fe acting on the dust H in the collecting portion R1 in a direction from a brush roller 11 side toward a surface-to-be-cleaned G side can be made sufficiently small. The abutting portion 307 is disposed outside the brush roller 11 on each of opposite end portion sides with respect to the rotational axis direction of the brush roller 11. In this embodiment, the abutting portion 307 is formed of ABS resin which is insulating resin as the insulator. The abutting portion 307 is mounted to the casing 306 or constituted integrally with the casing 306. In this embodiment, the abutting portion 307 has an arcuate shape (substantially semicircular shape) convex toward the surface-to-be-cleaned G along an outer configuration of the brush roller 11. The abutting portion 307 is for ensuring the collecting portion clearance L1 by 10 mm or more over a whole area of the brush roller 11 with respect to the rotational axis direction. Thus, in this embodiment, the electrostatic collecting device 300 includes a regulating member (abutting portion) 307 contacting the object-to-be-cleaned and for regulating a distance from the electroconductive member (core portion) 11b, passing through the collecting portion R1, to the object-to-be-cleaned. In this embodiment, the abutting portion 307 has the above-described arcuate shape, and therefore, even when an angle of the apparatus main assembly 301 to the surface-to-be-cleaned G is changed, the collecting portion clearance L1 can be maintained substantially constant. By this, even in the handheld cleaning device 300 designed light-weighted, the collecting portion clearance L1 can be maintained at an appropriate value.

As described above, according to this embodiment, in the cleaning device 300, the transfer efficiency of the dust H from the raisings 11a of the brush roller 11 onto the surface layer 12a of the recovering roller 12 can be improved.

### OTHER EMBODIMENTS

In the above, the present invention was described in accordance with specific embodiments, but the present invention is not limited to the above-described embodiments.

In the above-described embodiments, the image forming apparatus in which the electrostatic collecting device is used as the monochromatic image forming apparatus, but for example, the image forming apparatus may also be a color image forming apparatus including a plurality of image forming portions each provided with an image bearing member and a cleaning device (cleaning apparatus), or the like image forming apparatus.

Further, in the above-described embodiments, the image bearing member as the object-to-be-cleaned for the electrostatic collecting device used in the image forming apparatus was the photosensitive drum, but for example, may also be an intermediary transfer belt for feeding a primarily transferred toner image in order to secondarily transferring the toner image from the photosensitive drum onto a recording material, or the like member.

Further, in the above-described embodiments, the rotatable collecting body constituted by the endless belt member was the rotatable member provided with the raisings, but may also be a rotatable member provided with sheets (paddles). Similarly, in the above-described embodiments, the rotatable collecting body constituted by including the cylindrical member was the rotatable member provided with the raisings, but may be a rotatable member provided with sheets (paddles).

Further, in the above-described embodiments, the rotatable recovering body was the rotatable roller, but may also be an endless belt member stretched by a plurality of stretching rollers.

Further, the rotatable constituting member and the rotatable recovering body in the embodiments 4 to 6 were driven by the motor, but the present invention is not limited thereto. For example, a constitution in which the cleaning device is not provided with the driving source, such as a constitution in which the rotatable collecting body and the rotatable recovering body are rotated by transmitting thereto a rotational force of wheels rotated with movement of the cleaning device in contact with the object-to-be-cleaned, or the like constitution may also be employed.

The electrostatic collecting device according to the present invention can be used for various purposes other than the purposes mentioned in the above-described embodiments. For example, the electrostatic collecting device according to the present invention can be used for collecting the paper powder deposited on the surface of the recording material by constituting the electrostatic collecting device so that the rotatable collecting body is contacted to the recording material such as paper in the image forming apparatus. Further, the electrostatic collecting device according to the present invention can be used for collecting the paper powder from a surface of a roller or a belt (sheet feeding roller, conveying roller, conveyer belt, or the like) for feeding (conveying) the recording material by constituting the electrostatic collecting device so that the rotatable collecting body is contacted to the surface of the roller or the belt. Further, the electrostatic collecting device according to the present invention can be used for removing the toner on the surface of the image bearing member, or the like. Further, the electrostatic collecting device according to the present invention can be used as cleaning devices in various manufacturing facilities for cleaning glass substrates and various insulators or electric conductors as the object-to-be-cleaned, for example.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023−187239 filed on Oct. 31, 2023, which is hereby incorporated by reference herein in its entirety.

What is claimed is:

1. An electrostatic collecting device comprising:
a collecting member configured to collect a substance-to-be-collected from an object-to-be-cleaned and capable of being circumferentially moved;
a recovering member configured to recover the substance-to-be-collected from the collecting member and capable of being circumferentially moved; and
an electroconductive member formed of an electric conductor and provided so as to oppose the recovering member positioned in a recovering portion through the collecting member positioned in the recovering portion,
wherein the collecting member is formed of an insulator so as to form a collecting portion in contact with the object-to-be-cleaned and to form the recovering portion in contact with the recovering member, and electrostatically collects the substance-to-be-collected from the object-to-be-cleaned in the collecting portion while being circumferentially moved,
wherein the recovering member is formed of an insulator and electrostatically recovers the substance-to-be-collected from the collecting member in the recovering portion while being circumferentially moved, and
wherein when a shortest distance from the electroconductive member, passing through the collecting portion, to the object-to-be-cleaned is L1 and a shortest distance from the electroconductive member, passing through the recovering portion, to the recovering member is L2, the following relationship is satisfied:
$$L 1 > L 2.$$

2. An electrostatic collecting device according to claim 1, further comprising a rotatable collecting body including a rotatable core portion and an elastically deformable projection provided on an outer periphery of the core portion,
wherein the projection constitutes the collecting member, and
wherein the core portion constitutes the electroconductive member.

3. An electrostatic collecting device according to claim 2, wherein the projection is constituted by raising provided on the outer periphery of the core portion.

4. An electrostatic collecting device according to claim 2, wherein the projection is constituted by a sheet provided on the outer periphery of the core portion along a rotational axis direction of the core portion.

5. An electrostatic collecting device according to claim 4, wherein the rotatable collecting body includes an electric conductor sheet which is provided on the core portion adjacently to the sheet along the rotational axis direction of the core portion and which is formed of an electric conductor.

6. An electrostatic collecting device according to claim 5, wherein the electric conductor sheet is electrically conducted to the core portion.

7. An electrostatic collecting device according to claim 5, wherein the electric conductor sheet is fixed to a side surface of the sheet and is deformed together with the sheet.

8. An electrostatic collecting device according to claim 5, wherein the electric conductor sheet is provided so as to be sandwiched between two sheet portions, of the sheet, which are deformed by the recovering member in the recovering portion and which are adjacent to each other.

9. An electrostatic collecting device according to claim 5, wherein a length of the electric conductor sheet in a widthwise direction perpendicular to a longitudinal direction along the rotational axis direction of the core portion is shorter than a length of the sheet in the widthwise direction.

10. An electrostatic collecting device according to claim 9, wherein the length of the electric conductor sheet in the widthwise direction is not more than half of the length of the sheet in the widthwise direction.

11. An electrostatic collecting device according to claim 1, further comprising a rotatable collecting body including an endless belt member which is provided with an elastically deformable projection on an outer periphery thereof and which is capable of being circumferentially moved, and including a plurality of stretching rollers for stretching the belt member,
wherein the projection constitutes the collecting member,
wherein of the plurality of stretching rollers, one stretching roller provided opposed to the recovering member constitutes the electroconductive member, and
wherein of the plurality of stretching roller, another stretching roller provided opposed to the object-to-be-cleaned is formed of an insulator.

12. An electrostatic collecting device according to claim 11, wherein the projection is constituted by raising provided on an outer periphery of the belt member.

13. An electrostatic collecting device according to claim 1, further comprising a rotatable collecting body including a rotatable cylindrical member formed of an insulator and including an elastically deformable projection provided on an outer periphery of the cylindrical member,
wherein the projection constitutes the collecting member, and
wherein the electroconductive member is fixedly disposed in a hollow portion of the cylindrical member along at least a part of an inner peripheral surface of the cylindrical member so as to oppose the recovering member positioned in the recovering portion through the projection positioned in the recovering portion.

14. An electrostatic collecting device according to claim 13, wherein the projection is constituted by raising provided on an outer periphery of the cylindrical member.

15. An electrostatic collecting device according to claim 1, further comprising a rotatable recovering body including a surface layer and a base portion provided with the surface layer on an outer periphery thereof,
wherein the surface layer constitutes the recovering member, and
wherein the base portion is formed of an insulator.

16. An electrostatic collecting device according to claim 1, further comprising a rotatable recovering body including a surface layer, a base portion provided with the surface layer on an outer periphery thereof, and another electroconductive member provided so as to oppose the surface layer positioned in the recovering portion through the base portion,
wherein the surface layer constitutes the recovering member,
wherein the base portion is formed of an insulator, and
wherein when the shortest distance from the recovering member, passing through the recovering portion, to the recovering member is L2 and a shortest distance from the another electroconductive member, passing through the recovering portion, to a surface of the recovering member is L3, the following relationship is satisfied:
$$L 2 < L 3.$$

17. An electrostatic collecting device according to claim 16, wherein the another electroconductive member is provided in a position including a rotational axis of the rotatable recovering body.

18. An electrostatic collecting device according to claim 1, wherein the following relationship is satisfied:
$$L 2 / L 1 < 0.8 .$$

19. An electrostatic collecting device according to claim 1, wherein L2 is 8 mm or less.

20. An electrostatic collecting device according to claim 1, further comprising a regulating portion configured to regulate a distance from the electroconductive member, passing through the collecting portion, to the object-to-be-cleaned.
